(19) United States
(12) Patent Application Publication
(10) Pub. No.: US 2009/0146507 A1
(43) Pub. Date: Jun. 11, 2009

(54) Linear Motor Actuator

(75) Inventors: Akihiro Teramachi, Tokyo (JP); Toshiyuki Aso, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Shinagawa-ku, Tokyo (JP)

(21) Appl. No.: 11/910,131

(22) PCT Filed: Mar. 28, 2006
(86) PCT No.: PCT/JP2006/306365

§ 371 Date: Jan. 6, 2009

(30) Foreign Application Priority Data
Mar. 30, 2005 (JP) 2005-097051
Mar. 30, 2005 (JP) 2005-097052

(51) Int. Cl. H02K 41/03

(52) U.S. Cl. 310/12

(57) ABSTRACT

A linear motor actuator includes a raceway member 16 having a cylindrical shape in which a moving block moves in a hollow portion, the raceway member having a cross-sectional shape which has a narrower opening 15 than a width of the moving block 40 in part of the cylindrical shape and having a guide portion (rolling grooves 14 or the like) for guiding the moving block 40 in a cylinder axis direction on an inner surface of the cylindrical raceway member 16, the moving block 40 which is guided by the guide portion so as to move in the cylinder axis direction within the raceway member 16, a cylindrical or prismatic first magnet 18 which resides in an interior of the raceway member 16 to generate a magnetic force, and a second magnet (armatures 46 or the like) which resides on the moving block 40 side and which is shaped to encapsulate the first magnet 18.

### TECHNICAL FIELD

The present invention relates to a linear motor actuator which includes a motion guiding unit for guiding a target object which it moves.

### BACKGROUND ART

In recent years, a further automation has been being promoted in the field of assembly processing of mechanical products and electronic products. In automating the assembly processing, since the design of a mechanized portion of an assembling machine or control thereof is facilitated when a linear-type robot is used, the automation of assembly processing steps can be promoted for products whose cycle from development to sale is short. The production costs of such products can be reduced or high-quality products can be provided by the promotion of automation in the assembly processing steps.

Conventionally, there has been known an actuator which makes up a uniaxial robot by driving a ball screw by a servo motor which is externally mounted, converting a rotational motion of the ball screw into a linear motion by a ball nut which is thread fitted on the ball screw and causing the ball nut to be held on a linear motion guiding device via a floating mechanism.

In addition, there is known a linear motor including a rod-like stationary portion which is configured such that a large number of plate-like segment magnets are accommodated in a cylindrical body made of a non-magnetic material in such a manner as to be arranged in an axial direction and a moving portion having multiphase coils with the rod-like stationary portion disposed substantially horizontal while passing through the moving portion, wherein the rod-like stationary portion is configured such that the large number of plate-like segment magnets which are each formed substantially into an oval plate-like shape or rectangular plate-like shape are accommodated in the cylindrical body which is formed substantially into an oval shape or rectangular shape in cross section in such a manner as to be arranged in the axial direction, and cross sections of central through holes in the multiphase coils are formed substantially into an oval shape or rectangular shape which corresponds to the cross-sectional shape of the rod-like stationary portion (for example, refer to Patent Document No. 1).

It is described in the document that in this linear motor, the rigidity of the rod-like stationary portion against a bending moment is high, so that a rod-type linear motor having a long span can be provided.

In addition, there is known a linear motor actuator in which a moving element, which is movable in an axial direction of a rod-like stator having a field magnet, is fitted, a motion guiding device for guiding a motion of the moving element in the axial direction of the stator while supporting the load of the moving element is disposed between a base and the moving element, and a bearing for suppressing the deflection of the stator so as to prevent the contact of the moving element with the stator is provided, at least, at one end of a moving direction of the moving element (for example, refer to Patent Document No. 2).

In this linear motor actuator, it is stated that the contact of the stator with the moving element as a result of the deflection of the stator is prevented and that an air gap is secured between the moving element and the stator.

In addition, there is known a linear motor actuator including a raceway rail in which a ball rolling groove is formed on a side wall portion which is formed into a channel shape, a table structure which freely reciprocates within a guiding passage on the raceway rail, a field magnet fixed to the raceway rail, and armatures which make up a linear motor in conjunction with the field magnet and gives a thrust or a braking force along a longitudinal direction of the raceway rail to the table structure (for example, refer to Patent Document No. 3).

In the linear motor actuator described in Patent Document No. 3, since the armatures and the field magnet which make up the linear motor are accommodated in an interior of a linear guide device in such a manner as to be integrated with a slider and the raceway rail which make up the linear guide device, the linear motor actuator can be configured compact.

In addition, in the invention described in Patent Document No. 3, since the linear motor is not exposed to the outside of the raceway rail which is formed into the channel shape, the handling of the linear motor during transportation work and mounting work thereof is made easy. While the armatures of the linear motor actuator are fixed directly to a coupling top plate of the table structure, the field magnet is also only provided on a fixing base portion of the raceway rail, and since special brackets for mounting these components on the table structure and the raceway rail, respectively, are not necessary at all, the linear motor actuator can be manufactured inexpensively.

In addition, as another linear motor actuator, there is known a linear motor actuator in which the moving body is supported on a stationary portion such as a bed, a column or the like in such a manner as to freely reciprocate by employing a pair of linear guide devices, and a stator and a moving element are mounted on the stationary portion and the moving body, respectively, in such a manner as to face each other (for example, refer to Patent Document No. 4).

In addition, there are known Patent Document No. 5, Patent Document No. 6 and the like as inventions relating to configurations in which a linear guiding device is combined with a linear motor.

Patent Document No. 1: JP-A-2004-248490 (FIG. 4)

Patent Document No. 2: JP-A-2004-129316 (FIG. 1)

Patent Document No. 3: JP-A-2004-312983 (FIGS. 1 to 2)

Patent Document No. 4: JP-A-10-290560 (FIG. 1)

Patent Document No. 5: JP-A-2002-25229 (FIG. 2)

Patent Document No. 6: JP-A-2004-274059 (FIG. 2)

### DISCLOSURE OF THE INVENTION

### Problem that the Invention is to Solve

In the linear motor described in Patent Document No. 1, although it is said that the rigidity of the rod-like body portion against the bending moment is made large, so as to increase the span (the traveling distance of the moving portion) of the linear motor and that a large thrust can be obtained regardless of the small width dimension of the rod-like body portion, in order to provide a further compact linear motor actuator while maintaining the high rigidity, a new separate design needs to be adopted. In the linear motor actuator described in Patent Document No. 2, although it is described that since the air gap is secured between the moving element and the stator, the span (the traveling distance of the moving portion) of the linear motor can be made large, in order to provide a further compact linear motor actuator with higher rigidity, a new separate design needs to be adopted.

In the linear motor actuator described in Patent Document No. 3, since the armatures and the field magnet, which make up the linear motor, are accommodated in the interior of the linear guide device in such a manner as to be integrated with the slider and the raceway rail, which make up the linear guide device, the linear motor actuator has an advantage that it can be configured more compact than the linear motor actuators which are described in the other patent documents such as Patent Document No. 4, Patent Document No. 5 or Patent Document No. 6.

In addition, there exists in a manufacturing site where linear motor actuators are used a demand that an area dedicated for an assembling machine is made as small as possible so as to realize a reduction in production costs due to miniaturization of the assembling machine. In order to provide a further compact linear motor actuator while maintaining the high rigidity, a new design which has never been described in the aforesaid patent documents needs to be adopted.

The invention is such as to have been made to solve the aforesaid problems, and an object thereof is to provide a linear motor actuator which has a small cross-sectional area and a high rigidity with respect to torsion or bending and which is light in weight and compact in size.

In addition, another object of the invention is to provide a linear motor actuator which has a small cross-sectional area and a large thrust or holding force and which is inexpensive to be manufactured and easy to be handled.

### Means for Solving the Problem

According to a first aspect of the invention, there is provided a linear motor actuator characterized by including a raceway member having a cylindrical shape in which a moving block moves in a prismatic or cylindrical hollow portion, the raceway member having a cross-sectional shape which has a narrower opening than a width of the moving block in part of the cylindrical shape and having a guide portion for guiding the moving block in a cylinder axis direction on an inner surface of the cylindrical raceway member, a moving block which is guided by the guide portion so as to move in the cylinder axis direction within the raceway member, a first magnet which is formed into a cylindrical or prismatic shape and which resides in an interior of the raceway member to generate a magnetic force, and a second magnet which is formed into a shape which surrounds the first magnet and which resides on the moving block side to generate a magnetic force, wherein either the first magnet or the second magnet is an electromagnet which can control a thrust for moving the moving block.

According to a second aspect of the invention, there is provided a linear motor actuator characterized by including a raceway member having a cylindrical shape in which a moving block moves in a prismatic or cylindrical hollow portion, the raceway member having a cross-sectional shape which has a narrower opening than a width of the moving block in part of the cylindrical shape and having a guide portion for guiding the moving block in a cylinder axis direction on an inner surface of the cylindrical raceway member, a moving block which is guided by the guide portion so as to move in the cylinder axis direction within the raceway member, a first magnet which resides on an inner surface on the raceway member side to generate a magnetic force, and a second magnet which resides on the moving block side to generate a magnetic force, wherein either the first magnet or the second magnet is an electromagnet which can control a thrust for moving the moving block.

According to a third aspect of the invention, the linear motor actuator is characterized in that the guide portion of the raceway member has a plurality of rolling grooves in which rolling elements such as bearing balls or bearing rollers roll, and in that the moving block has rolling element guide grooves which hold the rolling elements from opposite sides of the rolling grooves and are supported on the rolling elements so as to move in the cylinder axis direction within the raceway member.

According to a fourth aspect of the invention, the linear motor actuator is characterized by having a plurality of moving blocks like the moving block, and in that a coupling member for coupling together the plurality of moving blocks is provided.

According to a fifth aspect of the invention, the linear motor actuator is characterized by having a guided portion which fits in the guide portion within a first cross section of a plurality of cross sections differing from each other which intersect the cylinder axis of the raceway member at right angles, and in that the second magnet is disposed within a second cross section which differs from the first cross section in an interior shape.

According to a sixth aspect of the invention, the linear motor actuator is characterized by having the rolling element guide groove within a first cross section of a plurality of cross sections differing from each other which intersect the cylinder axis of the raceway member at right angles, and in that the second magnet is disposed within a second cross section which differs from the first cross section in an interior shape.

According to a seventh aspect of the invention, the linear motor actuator is characterized in that the moving block and the second magnet are disposed within the same cross section which intersects the cylinder axis of the raceway member at right angles.

According to an eighth aspect of the invention, the linear motor actuator is characterized in that a covering member is provided which covers the whole of the raceway member and which is free to extend and contract in the cylinder axis direction of the raceway member.

According to a ninth aspect of the invention, there is provided a linear motor actuator characterized by including a raceway member having a cylindrical shape in which a moving block moves in a prismatic or cylindrical closed hollow portion, the raceway member having a guide portion for guiding the moving block in a cylinder axis direction on an inner surface of the cylindrical raceway member, a moving block which is guided by the guide portion so as to move in the cylinder axis direction within the raceway member, a magnet coupling for transmitting a displacement of the moving block to the outside of the raceway member, a first magnet which is formed into a cylindrical or prismatic shape and which resides on an inner surface on the raceway member side to generate a magnetic force, and a second magnet which is formed into a shape which surrounds the first magnet and which resides on the moving block side to generate a magnetic force, wherein either the first magnet or the second magnet is an electromagnet which can control a thrust for moving the moving block.

According to a tenth aspect of the invention, there is provided a linear motor actuator characterized by including a raceway member having a cylindrical shape in which a moving block moves in a prismatic or cylindrical closed hollow portion, the raceway member having a guide portion for guiding the moving block in a cylinder axis direction on an inner surface of the cylindrical raceway member, a moving block which is guided by the guide portion so as to move in the cylinder axis direction within the raceway member, a magnet coupling for transmitting a displacement of the moving block to the outside of the raceway member, a first magnet which resides on an inner surface on the raceway member side to generate a magnetic force, and a second magnet which resides on the moving block side to generate a magnetic force, wherein either the first magnet or the second magnet is an electromagnet which can control a thrust for moving the moving block.

### Advantages of the Invention

According to the first and second aspects, since the linear motor actuator includes, as the raceway member of the linear motor actuator, the raceway member having the cylindrical shape in which the moving block moves in the prismatic or cylindrical hollow portion, the raceway member having the cross-sectional shape which has the narrower opening than the width of the moving block in part of the cylindrical shape and having the guide portion for guiding the moving block in the cylinder axis direction on the inner surface of the cylindrical raceway member, the cross-sectional shape of the raceway member can be made to be close to a closed curve, whereby the geometrical moment of inertia of the raceway member can be made large. Consequently, the linear motor actuator which has high flexural rigidity and torsional rigidity can be provided, although it is small in cross-sectional area, light in weight and compact in size.

In addition, according to the first aspect, since there are provided the first magnet which is formed into the cylindrical or prismatic shape in the raceway member and the second magnet which is formed into the shape which surrounds the first magnet, the linear motor actuator which has a large thrust or holding force can be provided, although it is small in size and light in weight.

In addition, according to the second aspect, since the opening in an output shaft of the linear motor actuator can be made narrow, the linear motor actuator which is difficult for dust and foreign matters to enter from the outside thereof can be provided. Additionally, since the linear motor, the rolling groove and the like are provided in the interior of the raceway member which is formed into the cylindrical shape having the C-shaped cross section or the like, the handling of the linear motor actuator during transportation work and mounting work thereof is made easy. In addition, since the moving block is guided to move by the guide portion, no constituent members are brought into contact with the first magnet and the second magnet, and the safety handling can be provided.

Additionally, according to the first and second aspects, since the opening in the output shaft of the linear motor actuator can be made narrow, the linear motor actuator can be provided which makes it difficult for dust and foreign matters to enter it from the outside. In addition, since the linear motor, the rolling grooves and the like are provided in the interior of the raceway member which is formed into the cylindrical shape in cross section such as the C-shaped cross section, the handling of the linear motor actuator during transportation work and mounting work is facilitated. Additionally, since the moving block is guided to move in the guide portion, the contact of the constituent members with the first magnet and the second magnet is eliminated, so as to secure safety in handling.

In addition, according to the first and second aspect of the invention, by making the raceway member into the hollow prism or cylinder, the mounting of a dust protecting cover can be facilitated.

Additionally, according to the first and second aspects of the invention, since the cross-sectional shape of the raceway member is formed substantially into an arc-like shape, the raceway member can be manufactured of, for example, a pipe, the working process can be simplified, thereby making it possible to provide an inexpensive linear motor actuator.

According to the third aspect of the invention, since there are provided the plurality of rolling grooves in which rolling elements such as bearing balls or bearing rollers roll in the guide portion of the raceway member and there are provided the rolling element guide grooves which hold the rolling elements from opposite sides of the rolling grooves, so that the moving block is configured to move in the cylinder axis direction in the raceway member while being supported on the rolling elements, the moving block of the compact linear motor actuator can be made to move smoothly.

According to the fourth aspect of the invention, since there are provided the plurality of moving blocks like the moving block within the linear motor actuator, as well as the coupling member for coupling together the plurality of moving blocks, not only can the guiding rigidity of the moving block be increased but also the linear motor actuator which has the large thrust can be provided, although it is compact in size.

According to the fifth and sixth aspects of the invention, since there are provided the guided portion within the first cross section of the plurality of cross sections differing from each other which intersect the cylinder axis of the raceway member at right angles and the second magnet is disposed within the second cross section which differs from the first cross section in the interior shape, a large magnet can be used, whereby the linear motor actuator having the large thrust or holding force can be provided. In addition, since heat emitted from the armatures can be dissipated effectively, the rise in temperature of the armatures can be suppressed to some extent, whereby more current can be made to flow to the armatures. Consequently, the resulting linear motor actuator can be made to be a linear motor actuator having a large thrust or holding force.

Additionally, according to the seventh aspect of the invention, since the moving block and the second magnet are disposed within the same cross section which intersects the cylinder axis of the raceway member at right angles, the linear motor actuator which is compact in the cylinder axis direction (the longitudinal direction) can be provided.

In addition, according to the eighth aspect of the invention, since the covering member is provided which covers the whole of the raceway member and which is free to extend and contract in the cylinder axis direction of the raceway member, a high dust protecting effect can be obtained while maintaining the function as the actuator. Furthermore, the linear motor actuator can be provided which can be used even under an environment where there is much dust or an environment where a grinding liquid falls thereon.

Additionally, according to the ninth and tenth aspects of the invention, since the cylindrical raceway member in which the moving block moves in the hollow prismatic or cylindrical closed hollow portion is provided as the raceway member of the linear motor actuator, the geometrical moment of inertia of the raceway member can be made large. Consequently, the linear motor actuator which has high flexural rigidity and torsional rigidity can be provided, although it is small in cross-sectional area, light in weight and compact in size.

In addition, according to the ninth aspect of the invention, since there are provided the first magnet which is formed into the cylindrical or prismatic shape in the raceway member and the second magnet which is formed into the shape which surrounds the first magnet, the linear motor actuator which has a large thrust or holding force can be provided, although it is small in size and light in weight.

Additionally, according to the ninth and tenth aspects of the invention, since the magnet coupling is provided for transmitting the displacement of the moving block to the outside of the raceway member, the opening in the linear motor actuator can be eliminated. Consequently, the linear motor actuator can be provided which prevents the entrance of dust and foreign matters from the outside even in the event that no special covering member is provided.

In addition, according to the ninth and tenth aspects of the invention, since the raceway member can be manufactured of a pipe material, the working process can be simplified, thereby making it possible to provide an inexpensive linear motor actuator.

### BEST MODE FOR CARRYING OUT THE INVENTION

Hereinafter, a best mode for carrying out the invention will be described based on the drawings. Note that the invention is not limited to embodiments below.

FIG. 1 is a perspective view of a linear motor actuator according to a first embodiment of the invention.

As is shown in the same figure, a raceway member 16 of a linear motor actuator 10 has a cylindrical shape of a C-shaped cross section which has an opening 15 which is narrower than a width of a moving block 40 in part of a cylinder which is formed into a hollow prismatic or cylindrical shape and is formed into the cylindrical shape having a guide portion (a rolling groove 14 or the like) which guides the moving block 40 on an inner surface of the cylinder in a cylinder axis direction.

The linear motor actuator 10 includes housings 30, 32 which fix the raceway member 16 from both ends thereof and the moving block 40 which is made to freely move relative to the cylinder axis direction of the raceway member 16 by including a guided portion (a rolling element guide groove 42 or the like) which can be fitted in the guide portion.

A sliding bearing in which the guide portion and the guided portion are fitted together may be used or a rolling element bearing may be used in the guide portion. In the example shown in the same figure, as the guide portion, a plurality of rolling grooves 14 are used in which a large number of rolling elements 12 such as bearing balls, bearing rollers and the like roll in the cylinder axis direction.

The moving block 40 has rolling element guide grooves 42 (one mode of the guided portion) which hold to guide the rolling elements 12 from opposite sides of the rolling grooves 14 and endless recirculation paths 44 which allow the rolling elements 12 to be recirculated in interiors thereof and is configured to freely move relative to the cylinder axis direction of the raceway member 16.

A cylindrical or prismatic magnet 18 (one mode of the first magnet) is provided in an interior of the raceway member 16 which has a plurality of magnetic poles for outputting lines of magnetic force in an alternating fashion over the cylinder axis direction of the raceway member 16, and an optical, magnetic or other type of scale 20 for use in measuring a moving amount of the moving block 40 side is provided on an inner surface of the interior of the raceway member 16.

A cylindrical or prismatic integrally constructed multi-pole magnet may be used to construct the magnet 18, or a configuration may be adopted in which cylindrical segment magnets are accommodated in an interior of a cylindrical cylinder body which is made of a nonmagnetic material in such a manner as to be arranged axially with the same magnetic poles made to face each other. In addition, in the example shown in the same figure, although the cross section of the magnet 18 is circular, an oval and rectangular, or polygonal cross section may be used in order to reduce the deflection of the magnet 18 and increase the thrust of the linear motor actuator 10.

On the moving block side 40, there are provided armatures 46 (one mode of the second magnet, refer to FIGS. 2 and 3) which make use of a magnetic force outputted by the magnet 18 which is provided on the raceway member 16 side to generate a magnetic force for generating a thrust in the cylinder axis direction of the raceway member 16, an encoder head 48 which is a reading device of optical, magnetic or other type for use in measuring a moving amount of the moving block 40 side and a slider 50 for transmitting a displacement of the moving block 40 from the opening 15 in the raceway member 16 to a target object to be driven.

In the example shown in FIG. 1, the first magnet and the second magnet are magnets which can control thrust for moving the moving block 40. A permanent magnet may be used for either of the magnets.

In the endless recirculation path 44 in the moving block 40, there are disposed the rolling elements 12 and a retainer 54 which has a shape which matches outer circumferential surfaces of the rolling elements 12 such as bearing balls or bearing rollers so as to hold the rolling elements 12 and serves to reduce resistance and wear which are generated due to contact of the adjacent rolling elements 12 with each other. Note that the retainer 54 may be omitted depending upon applications.

End plates 60, 62, which hold the endless recirculation paths 44 and the like, are provided at both ends of the moving block 40. A cable clamper 66 (refer to FIG. 3) for fixing cables 64 may be provided in this end plate 60. The cables 64 are such as to transmit electric power that is to be supplied to the encoder head 48 and a magnetic pole sensor 72 and output signals outputted therefrom, as well as electric power that is to be supplied to the armatures 46. The other ends of the cables 64 which are fixed to the moving block 40 side by the cable damper 66 are connected to a connector provided in the housing 30.

In the example shown in FIG. 1, the slider 50, which constitutes an output shaft of the linear motor actuator 10, is supported in such a manner as to freely slide relative to the cylinder axis direction of the raceway member 16 by the rolling elements 12 such as bearing balls or bearing rollers. Consequently, a position or speed control can be implemented on a target object to be driven which is connected directly with the slider 50 by the linear motor generating a thrust which is made up of the magnet 18, the armatures 46, the magnetic pole sensor 72, the scale 20, the encoder head 48 and the like.

By mounting the housings 30, 32 of the linear motor actuator 10 shown in the same figure to the rear of a pulling vehicle (a tractor), the linear motor actuator 10 can be used for an application in which a hitch ball (a spherical protruding portion) provided on the slider 50 is made to constitute a fifth axle of sliding type of the pulling vehicle (the tractor).

In the case where the linear motor actuator 10 is used in this way, a coupler of a pulled vehicle (a trailer) is coupled to the hitch ball of the linear motor actuator 10, so as to move the slider 50 to the left or right according to a steered angle of a steering wheel of the pulling vehicle (the tractor) or the like in order to reduce a difference in turning radius of rear inner wheels of the pulled vehicle (the trailer) when turning to the right or left and to increase the turning capability of the pulled vehicle (the trailer) when reversing.

FIG. 2 is a diagram showing a section taken along the line A-A′ of the linear motor actuator 10 according to the first embodiment shown in FIG. 1.

The section taken along the line A-A′ in FIG. 1 is a section which intersects the cylinder axis of the raceway member 16 at right angles. The embodiment shown in FIG. 2 is an embodiment in which the moving block 40 and the armatures 46 (the second magnet) are disposed within the same section which intersects the cylinder axis of the raceway member at right angles.

As is shown in FIG. 2, the raceway member 16 of the linear motor actuator 10 has the cylindrical shape of the C-shaped cross section having the opening 15 which results from cutting part of a cylindrical shape. The raceway member 16 has in an interior thereof the plurality of rolling grooves 14 in which the large number of rolling elements 12 such as bearing balls or bearing rollers roll in the cylinder axis direction.

In the example shown in the same figure, a two-row Gothic arch contact construction is adopted in which loads in two directions are supported by employing two rows of rolling element recirculation systems in such a way that the rolling elements 12 contact the rolling element grooves 14 of the raceway member 16 in two locations per ball. The invention is not limited to the example in which the two rows of rolling grooves 14 are provided but may be made to adopt a four-row circular contact construction in which four rows of rolling element recirculation systems of which each system supports a force in one direction by virtue of a single row of rolling elements are provided in such a way that support directions thereof are at right angles to each other. In addition, two rows of rolling grooves which are in angular contact with each other may be provided in two locations (in rolling grooves may be provided in four locations) or may be provided in four or more locations.

In addition, a configuration can also be adopted in which the moving block is made to perform a sliding motion relative to the raceway member without interposing any rolling element between the raceway member and the moving block.

As is shown in the same drawing, the moving block 40 has the rolling element guide grooves 42 for guiding the rolling elements 12 and the endless recirculation paths 44 for recirculating the rolling elements 12 in interiors of the endless recirculation paths 44. The circular or prismatic magnet 18, which has the plurality of magnetic poles for outputting alternately lines of magnetic force over the cylinder axis direction of the raceway member 16, is provided on the inner surface of the raceway member 16. In addition, the scale 20 for use in measuring the moving amount of the moving block 40 is provide on the inner surface of the raceway member 16.

As is shown in the same figure, the armatures 46 are fixed on the moving block 40 for generating a magnetic force for generating a thrust in the cylinder axis direction of the raceway member 16 by making use of the magnetic force generated by the magnet 18 provided on the raceway member 16 side. In addition, the slider 50 is fixed to the moving block 40 for connecting the moving block 40 with equipment lying outside the linear motor actuator 10.

As is shown in FIG. 2, in the linear motor actuator 10 of the invention, since the configuration is adopted in which the raceway member 16 encapsulates the moving block 40, even in the event that the rolling elements 12 are dislocated from the rolling grooves 14 of the raceway member 16, there occurs no case where the moving block 40 is dislocated from the raceway member 16.

In addition, in the linear motor actuator 10 of the invention, since the armatures 46 are configured to surround the first magnet, large magnets can be used for the first magnet and the second magnet. Consequently, the linear motor actuator having a large thrust or holding force can be provided, although the linear motor actuator is small in size and light in weight.

FIG. 3 is a diagram showing a section taken along the line B-B′ of the linear motor actuator 10 according to the first embodiment shown in FIG. 2.

As is shown in the same figure, the plurality of rolling grooves 14 in which the large number of rolling elements 12 such as bearing balls or bearing rollers roll in the cylinder axis direction are provided on the inner surface of the raceway member 16 of the linear motor actuator 10. Consequently, the moving block 40 can move freely and smoothly relative to the cylinder axis in the interior of the raceway member 16.

The magnet 18 having the plurality of magnetic poles for outputting lines of magnetic force in the alternating fashion over the cylinder axis direction of the raceway member 16 is provided in the interior of the raceway member 16, and the scale 20 for use in measuring a moving amount of the moving block 40 is provided on the interior side surface of the raceway member 16.

The moving block 40 includes the plurality of armatures 46 for generating the magnetic force for generating the thrust in the cylinder axis direction of the raceway member 16 by making use of the magnetic force outputted by the magnet 18 provided on the raceway member 16 side, coil separators 43 for fixing the armatures 46 at both ends of the moving block 40 in predetermined positions and a plurality of coil separators 45 for fixing the respective armatures 46 in predetermined positions relative to each other. In addition, the moving block 40 includes the slider 50 which connects the moving block 40 with the equipment lying outside the linear motor actuator 10.

In the moving block 40, there are provided the endless recirculation paths 44 which allow the rolling elements 12 to be recirculated in the interiors thereof and the end plates 60, 62 for holding the endless recirculation paths 44 and the like. In addition, in the example shown in the same figure, the encoder head 48 for measuring a moving amount of the moving block 40 side is mounted on the end plate 62 of the moving block 40.

In addition, the magnetic pole sensor 72 for measuring a magnetic force generated by the magnet 18 is mounted on the end plate 60 of the moving block 40. The mounting position of the magnetic pole sensor 72 is not limited to the position shown in FIG. 3, and hence, any position can be used, provided that it allows the detection of the magnetic poles of the magnet 18. In additions since the magnetic pole sensor 72 can be omitted when the positions of the magnet 18 and the armatures 46 are established for use by a so-called power-factor detection method or the like, the linear motor actuator 10 can be miniaturized further.

On the moving block 40, there are provided the encoder head 48 and the magnetic pole sensor 72, and the cable damper 66 for fixing the cables 64 to the moving block 40 side.

The various cables 64 which exit from the cable damper 66 employ, for example, coiled or telescopically coiled cables, of which the other ends are connected to the connector provided in the housing 30. In addition, although not shown in the same figure, an origin sensor for the encoder and a driving limit switch may be provided within the linear motor actuator 10.

As is shown in the same figure, the armatures 46 which generate the thrust are mounted on the moving block 40 side. Since the slider 50 is mounted on the moving block 40, the slider 50 moves in the cylinder axis direction by virtue of the thrust generated in the armatures 46, thereby making it possible to control the position and speed thereof.

In addition, when the position or speed control is performed on the slider 50 shown in the same figure, this is realized by connecting a driver (not shown) for outputting a controlling electric power for servo controlling, for example, the plurality of armatures 46 to the linear motor actuator 10.

Positional information outputted by the encoder head 48 and positional information of the magnet which is outputted by the magnetic pole sensor 72 are inputted into the driver, and a host computer for outputting a position command and a speed command or a sequencer is connected to the driver.

When information on a position command or information on a speed command is inputted into the driver from the host controller or the like, the driver outputs controlling drive current to the respective armatures 46 based on the positional information outputted by the encoder head 48 or the positional information on the magnet which is outputted by the magnetic pole sensor 72, so as to control the position or speed of the driver 50.

FIG. 4 is a diagram which compares the cross-sectional shape of the cylindrical raceway member of the linear motor actuator according to the first embodiment of the invention with a cross-sectional shape of a conventional U-shaped raceway member.

The cross section of the raceway member 16 according to the first embodiment of the invention is different from a conventional raceway member 416 and is characterized in that extending portions 17 of the raceway member 16 project as far as above the moving block 40, so as to have the opening 15 which is narrower than the width of the moving block 40.

By this configuration, the cross-sectional shape of the raceway member 16 becomes close to a closed curve, whereby the geometrical moment of inertia of the raceway member 16 can be made large although it is kept compact in external dimensions. Because of this, the linear motor actuator having high rigidity such as flexural rigidity, torsional rigidity and the like can be obtained.

FIG. 5 is such as to compare shapes of the raceway member 16 according to the first embodiment of the invention and the conventional raceway member 416 having the U-shaped cross-sectional shape when their geometrical moments of inertia “IX-X” about x-x axes are made substantially to match. In the same figure, values of “AREAs” represent cross-sectional areas of planes which intersect the cylindrical axes of the raceway members, and values of the cross-sectional areas are proportional to masses of the raceway members.

As is shown in the same figure, when attempting to obtain the same geometrical moment of inertia about the X-X axis as that of the raceway member 416 having the U-shaped cross section by forming the raceway member 16 into the cylindrical shape in cross section, the value of the cross-sectional area “AREA” can be reduced to about one third. This means that the mass of the raceway member can be reduced to about one third while maintaining the rigidity.

In addition, since in the linear motor actuator of the invention, the geometrical moment of inertia “IX-X” about the X-X axis and a geometrical moment of inertia “IY-Y” about a Y-Y axis both can be made to be substantially the same values, a uniform flexural rigidity can be obtained even for a load in every direction.

FIG. 6 is a perspective view of a state in which a dust protecting cover member is mounted on the linear motor actuator of the invention.

The same figure shows an example in which a ring-like cover mounting member 90 is mounted on the slider 50 which can move in the cylinder axis direction of the linear motor actuator. Then, corrugated dust protecting cover members 92, which can extend and contract in the cylinder axis direction of the raceway member, are mounted on both sides of the cover mounting member 90, respectively.

This cover member 92 is mounted on the cover mounting member 90 and a housing 94 via a band or metallic fixture. As a material of the cover member 92, rubber, fabric or aluminum fibers can be used.

FIG. 7 is a view of a cross section of a linear motor actuator according to a second embodiment of the invention which intersects a cylinder axis direction of a raceway member at right angles.

As is shown in FIG. 7, a raceway member 16 of a linear motor actuator 10 has a closed cylindrical cross-sectional shape, and a portion of the raceway member 16 through which magnetic force of a magnet coupling passes (a portion between an external magnet coupling 94 and an internal magnet coupling 96) is made of a non-magnetic material.

The raceway member 16 has in an interior thereof a plurality of rolling grooves 14 (one mode of the guide portion) in which a large number of rolling elements 12 such as bearing balls or bearing rollers roll in the cylinder axis direction. In the example shown in the same figure, although the rolling grooves 14 are provided in two locations, two rows of rolling grooves may be provided in two locations (the rolling grooves are provided in four locations in total) or may be provided in four or more locations.

A moving block 40 shown in FIG. 7 has a similar configuration to that of the moving block shown in FIG. 1, 2 or 3. In addition, similarly, a circular or prismatic magnet 18, which has a plurality of magnetic poles for outputting lines of magnetic force in an alternating fashion over the cylinder axis direction of the raceway member 16 is provided in the interior of the raceway member 16. In addition, a scale 20 for use in measuring a moving amount of the moving block 40 side is provided on an inner surface of the raceway member 16.

The internal magnet coupling 96 is provided on an upper portion of the moving block 40 shown in FIG. 7 for transmitting a displacement of the moving block 240 or the like to the outside in order to transmit a drive force of the linear motor actuator 10 to the outside thereof in a non-contact fashion. The internal magnet coupling 96 radiates lines of magnetic force towards the outside of the raceway member 16.

The external magnet coupling 94 is provided outside of the raceway member 16 for driving a slider 98 provided outside of the linear motor actuator 10 by absorbing the magnetic force radiated by the internal magnet coupling 96. In addition, the slider 98 is such as to be used also in vacuo or a clean room and to be guided along guide shafts 99 or the like.

FIG. 8 is view of a cross section taken along the line B1-B′1 of the linear motor actuator 10 shown in FIG. 7.

As is shown in FIG. 8, the plurality of rolling grooves 14 (the mode of the guide portion) in which the number of rolling elements 12 such as bearing balls or bearing rollers roll in the cylinder axis direction and the scale 20 for use in measuring a moving amount of the moving block 40 side are provided on the inner surface of the raceway member 16 of the linear motor actuator 10.

The cylindrical or prismatic magnet 18 (a mode of the first magnet) having the plurality of magnetic poles for generating lines of magnetic force in the alternating fashion over the cylinder axis direction of the raceway member 16 is provided in the interior of the raceway member 16.

The moving block 40 includes a plurality of armatures 46 for generating magnetic force for generating a thrust in the cylinder axis direction of the raceway member 16 by making use of the magnetic force outputted by the magnet 16 provided on the raceway member 16 side, coil separators 43 for fixing the armatures 46 at both ends of the moving block 40 in predetermined positions and a plurality of coil separators 45 for fixing the respective armatures 46 in predetermined positions relative to each other.

The external magnet coupling 94 is provided outside of the raceway member 16 for absorbing the magnetic force radiated by the internal magnet coupling 96 to thereby drive the slider provided outside of the linear motor actuator 10.

As is shown in FIG. 8, by forming the cross-sectional shape of the raceway member 16 of the linear motor actuator 10 into the closed cylindrical shape, the interior of the raceway member 16 and the exterior of the raceway member 16 can be cut off. Consequently, the linear motor actuator 10 can be applied to a field in which an effect of evaporated lubricant of the rolling elements 12 is wanted to be avoided as used, for example, in a vacuum atmosphere, to a field in which there is much dust as in a case where grinding liquid or cuttings fall thereon, to a food-processing field in which mixing of foreign matters is wanted to be avoided, and to various industrial fields which employ clean rooms.

FIG. 9 is a perspective view of a linear motor actuator according to a third embodiment of the invention.

As is shown in the same figure, a linear motor actuator 210 includes a cylindrical raceway member 16 which has a cylindrical shape of a C-shaped cross section which has an opening 15 which is narrower than a width of a moving block 240 or the like in part of the cylindrical shape and a guide portion (a rolling groove 14 or the like) for guiding the moving block 240 or the like in a cylinder axis direction, housings 30, 32 which fix the raceway member 16 from both ends thereof and the moving block 240 and the like which are free to move relative to the cylinder axis direction of the raceway member 16 by including a guided portion (a rolling element guide groove 42 or the like) which can be fitted in the guide portion.

A sliding bearing in which the guide portion and the guided portion are fitted together may be used or a rolling element bearing may be used in the guide portion. In the example shown in the same figure, as the guide portion, a plurality of rolling grooves 14 are used in which a large number of rolling elements 12 such as bearing balls, bearing rollers and the like roll in the cylinder axis direction.

The moving block 240 or a moving block 241 has rolling element guide grooves 42 (one mode of the guided portion) which hold to guide the rolling elements 12 from opposite sides of the rolling grooves 14 and endless recirculation paths 44 which allow the rolling elements 12 to be recirculated in interiors thereof to thereby be configured to freely move relative to the cylinder axis direction of the raceway member 16. In addition, the moving block 240 and the moving block 241 are coupled together by a slider 250 (a coupling member) via a heat insulating material 270.

A cylindrical or prismatic magnet 18 (one mode of the first magnet) is provided in an interior of the raceway member 16 which has a plurality of magnetic poles for outputting lines of magnetic force in an alternating fashion over the cylinder axis direction of the raceway member 16, and a scale 20 for use in measuring a moving amount of the moving block 240 and moving block 241 side is provided on an inner surface of the raceway member 16.

A plurality of armatures 246 (one mode of the second magnet) for generating a thrust in the cylinder axis direction of the raceway member 16 by making use of magnetic force outputted by the magnet 18 provided on the raceway member 16 side and a coil housing 247 for fixing the respective armatures 246 are provided intermediately between the moving block 240 and the moving block 241.

The coil housing 247 transmits thrust generated by the armatures 246 to the slider 250 which transmits the thrust to equipment lying outside of the linear motor actuator 210. In addition, fins are provided on the coil housing 247 for dissipating heat generated by the armatures 246. In addition, part of heat that is transmitted from the armatures 246 to the coil housing 247 is dissipated by being transmitted to the slider 250.

Since the slider 250, the moving block 240 and the moving block 241 are mounted via the heat insulating material 270, the rise in temperature of the moving block 240 and the moving block 241 can be prevented to some extent.

In an example shown in FIG. 9, the first magnet and the second magnet are electromagnets which can control the thrust for moving the moving block 240 and the like. A permanent magnet may be made to be used for either of the first magnet or the second magnet.

As is shown in FIG. 9, in the third embodiment of the invention, the guided portions such as the rolling element guide grooves 42 are disposed within a first cross section of a plurality of cross sections which intersect the cylinder axis of the raceway member 16 at right angles, and the second magnet is disposed within a second cross section which differs from the first cross section having the guided portions in inner configuration.

In addition, in the example shown in the same figure, while the second magnet is described as being disposed between the rolling element guide groove 42 (the guided portion) of the moving block 240 and the rolling element guide groove 42 (the guided portion) of the moving block 241, the invention is not limited to this embodiment and hence, the second magnet may be provided on both sides of the moving block 240 and the moving block 241.

In addition, the two moving blocks, the moving block 240 and the moving block 241, are not always necessary, and either one of the moving block 240 and the moving block 241 may be used and the second magnet may be disposed on one side or both sides of either of the moving blocks.

In the endless recirculation paths 44 in the moving block 240 and the moving block 241, there are disposed the rolling elements 12 and a retainer 54 which has a shape which matches outer circumferential surfaces of the rolling elements 12 such as bearing balls or bearing rollers so as to hold the rolling elements 12 and serves to reduce resistance and wear which are generated due to contact of the adjacent rolling elements 12 with each other.

End plates 260, 261 for holding the endless recirculation path 44 and the like are provided at both ends of the moving block 240. In the example shown in the same figure, a cable damper 66 (refer to FIG. 12) is provided on the end plate 260 for fixing cables 64 which connect to a magnetic pole sensor 72 (refer to FIG. 12) and the armatures 246 to the moving block 240 side. The various cables 64 which exit from the cable damper 66 employ, for example, coiled or telescopically coiled cables, of which the other ends are connected to a connector provided in the housing 30. In addition, although not shown in the same figure, an origin sensor for the encoder and a driving limit switch may be provided within the linear motor actuator 10. Note that end plates 262, 263 for holding the endless recirculation path 44 and the like are also provided at both ends of the moving block 241.

As is shown in FIG. 9, since the slider 250, which constitutes an output shaft of the linear motor actuator 210, is supported in such a way as to freely slide relative to the cylinder axis direction of the raceway member 16 by the rolling elements 12 such as bearing balls or bearing rollers, a positional or speed control can be performed on a target object to be driven which is connected directly with the slider 250 by the linear motor generating the thrust which is made up of the magnet 18, the armatures 246, the magnetic pole sensor 72, the scale 20, the encoder head 48 and the like.

FIG. 10 is a diagram showing a cross section taken along the line C-C′ of the linear motor actuator 210 according to the third embodiment of the invention shown in FIG. 9.

The cross section taken along the line C-C′ in FIG. 9 is defined as a second cross section which intersects the cylinder axis of the raceway member 16 at right angles. The embodiment shown in FIG. 10 is an embodiment in which the armatures 246 (the second magnet) are disposed within the second cross section which dose not have the guided portion (for example, the rolling element guide grooves 42 or the like) of a plurality of different cross sections which intersect the cylinder axis of the raceway member 16 at right angles.

Although the raceway member 16 of the linear motor actuator 210 shown in FIG. 10 has the cylindrical shape of the C-shaped cross section which has the opening 15 provided by cutting part of the cylindrical shape, a closed cylindrical cross-sectional shape such as shown in FIG. 7 may be adopted.

As is shown in FIG. 10, the raceway member 16 has in the interior thereof the plurality of rolling grooves 14 (the mode of the guide portion) in which the large number of rolling elements 12 such as bearing balls or bearing rollers roll in the cylinder axis direction. In the example shown in the same figure, although the rolling grooves 14 are provided in two locations, two rows of rolling grooves may be provided in two locations (the rolling grooves may be provided in four locations in total) or may be provided in four or more locations.

The armatures 246 are mounted on the slider 250 via the coil housing 247. The armature 246 is made to generate a thrust in the cylinder axis direction of the raceway member 16 by making use of the magnetic force outputted by the magnet 18 provided on the raceway member 16 side. In addition, heat generated from the armatures 246 is transmitted to the slider 250 via the coil housing 247, so as to be radiated to the outside of the linear motor actuator 210.

FIG. 11 is a diagram showing a cross section taken along the line D-D′ of the linear motor actuator 210 according to the third embodiment of the invention shown in FIG. 9.

The cross section taken along the line D-D′ in FIG. 9 is defined as a first cross section which intersects the cylinder axis of the raceway member 16 at right angles. The embodiment shown in FIG. 11 is the embodiment in which the rolling element guide groove 42 (the one mode of the guided portion) is disposed within the first cross section which does not have the second magnet (for example, the armatures 246 or the like) in the different cross sections which intersect the cylinder axis of the raceway member 16.

The moving block 241 has, as is shown in FIG. 11, the rolling element guide grooves 42 (the one mode of the guided portion) for guiding the rolling elements 12 and the endless recirculation paths 44 which allow the rolling elements 12 to be recirculated in the interiors thereof.

The magnet 18 (the mode of the first magnet) which has the plurality of magnetic poles for outputting alternately lines of magnetic force over the cylinder axis direction of the raceway member 16 is provided in the interior of the raceway member 16. In addition, the scale 20 for use in measuring a moving amount of the moving block 240 side is provided on the inner surface of the raceway member 16, and the encoder head 48 is provided on a lower side of the moving block 241.

FIG. 12 is a diagram showing a cross section taken along the line E-E′ of the linear motor actuator 210 of the third embodiment shown in FIG. 11.

As is shown in the same figure, since the plurality of rolling grooves 14 (the mode of the guide portion) in which the large number of rolling elements 12 such as bearing balls or bearing rollers roll in the cylinder axis direction are provided on the inner surface of the raceway member 16 of the linear motor actuator 210, the moving block 240 and the moving block 241 can move freely and smoothly in the interior of the raceway member in the cylinder axis direction.

The cylindrical or prismatic magnet 18 (the one mode of the first magnet) and the scale 20 for use in measuring moving amounts of the moving block 240 and moving block 241 side are provided in the interior of the raceway member 16.

The plurality of armatures 246 for generating magnetic force for generating thrust in the cylinder axis direction of the raceway member 16 by making use of the magnetic force outputted by the magnet 18 provided on the raceway member 16 side, coil separators 243 for fixing the armatures 246 at both ends of the coil housing 247 in predetermined positions, and a plurality of coil separators 245 for fixing the respective armatures 246 in predetermined positions are provided in the interior of the coil housing 247 on the moving block 240 and moving block 241 side.

Heat generated from the armatures 246 is radiated to the outside of the linear motor actuator 210 via the coil housing 247 and the slider 250. Consequently, since the rise in temperature of the armatures 246 can be suppressed to some extent, more current is allowed to flow to the armatures 246, whereby the linear motor actuator can be made to provide a large thrust.

In the moving block 240 and the moving block 241, there are provided the endless recirculation paths 44 which allows the rolling elements 12 to be recirculated in the interiors thereof and the end plates 260, 261, 262, 263 for holding the endless recirculation paths 44 and the like. In addition, in the example shown in the same figure, the encoder head 48 for measuring a moving amount of the moving block 241 side is mounted on the end plate 263 or the like on the moving block 241 side.

In addition, the magnetic pole sensor 72 for measuring magnetic force generated by the magnet 18 is mounted on the end plate 260 on the moving block 240 side. The mounting position of the magnetic pole sensor 72 is not limited to the position shown in FIG. 12, and hence, any position may be used, provided that the position allows the magnetic poles of the magnet 18 to be detected. When the linear motor actuator 210 is used in an open loop with respect to the magnetic poles of the magnet 18, the magnetic pole sensor 72 can be omitted.

In addition, as is shown in the same figure, the armatures 246 for generating thrust are mounted on the slider 250, and the moving block 240 and the moving block 241, which move freely in the cylinder axis direction, are mounted on the slider 250 via the heat insulating material 270. Consequently, the slider 250 moves in the cylinder axis direction by virtue of the trust generated in the armatures 246, thereby making it possible to perform a position or speed control thereon.

As is shown in FIGS. 10 and 11, since the raceway member 16 of the linear motor actuator 210 according to the third embodiment of the invention is also configured to encapsulate the moving block 240 and the moving block 241, even in the event that the rolling elements 12 are dislocated from the rolling grooves 14 of the raceway member 16, there occurs no case where the moving block 240 and the moving block 241 are dislocated from the raceway member 16.

In addition, when the position or speed control is performed on the slider 250 of the linear motor actuator 210 shown in the same figure, this is realized by connecting a driver (not shown) for outputting a controlling electric power for controlling, for example, the plurality of armatures 246 in a micro-step fashion to the linear motor actuator 210.

When information on a position command or information on a speed command is inputted into the driver from the host controller or the like, the driver outputs controlling drive current to the respective armatures 246 based on the positional information outputted by the encoder head 48 or the positional information on the magnet which is outputted by the magnetic pole sensor 72, so as to control the position or speed of the driver 250.

Similar to the first embodiment shown in FIG. 4, the linear motor actuator 210 of the third embodiment is also characterized by a configuration in which extending portions 17 of the raceway member 16 project as far as above the moving block 240 or the moving block 241.

By this configuration, the cross-sectional shape of the raceway member 16 becomes close to a closed curve, whereby the geometrical moment of inertia of the raceway member 16 can be made large although it is kept compact in external dimensions. Because of this, the linear motor actuator having high rigidity such as flexural rigidity, torsional rigidity and the like can be obtained.

In addition, by forming the cross-sectional configuration of the raceway member 16 substantially into the cylindrical shape, values of the cross-sectional area and mass of the raceway member 16 can be reduced while maintaining the geometrical moment of inertia thereof high. In addition, a uniform flexural rigidity can be obtained for a load in every direction.

In addition, a dust protecting cover member, which is similar to that shown in FIG. 6, can be mounted also on the linear motor actuator 210 of the third embodiment.

Additionally, the raceway member 16 of the linear motor actuator 210 of the third embodiment can be configured into a raceway member having a closed cylindrical cross-sectional shape as is shown in FIGS. 7 and 8 and can be configured so as to control a target object to be driven by employing magnet couplings. In this case, too, since the interior of the raceway member and the exterior of the raceway member can be cut off by forming the raceway member into the closed cylindrical shape in cross section, the linear motor actuator 210 can be applied to an application in which it is used in a vacuum atmosphere, to an application in which there is much dust, to a food-processing field, and to an application in which it is used in a clean room.

FIG. 13 is a perspective view of a linear motor actuator according to a fourth embodiment of the invention.

As is shown in the same figure, a raceway member 16 of a linear motor actuator 310 has a cylindrical shape of a C-shaped cross section which has an opening 15 which is narrower than a width of a moving block 340 in part of a cylinder which is formed into a hollow prismatic or cylindrical shape and is formed into the cylindrical shape having a guide portion (a rolling groove 14 or the like) which guides the moving block 340 on an inner surface of the cylinder in a cylinder axis direction.

The linear motor actuator 310 includes housings 30, 32 which fix the raceway member 16 from both ends thereof and the moving block 340 which is made to freely move relative to the cylinder axis direction of the raceway member 16 by including a guided portion (a rolling element guide groove 42 or the like) which can be fitted in the guide portion.

A sliding bearing in which the guide portion and the guided portion are fitted together may be used or a rolling element bearing may be used in the guide portion. In the example shown in the same figure, as the guide portion, a plurality of rolling grooves 14 are used in which a large number of rolling elements 12 such as bearing balls, bearing rollers and the like roll in the cylinder axis direction.

The moving block 340 has rolling element guide grooves 42 (one mode of the guided portion) which hold to guide the rolling elements 12 from opposite sides of the rolling grooves and endless recirculation paths 44 and is configured to freely move relative to the cylinder axis direction of the raceway member 16.

In an interior of the raceway member 16, there are provided a plurality of magnets 318 (one mode of the first magnet) which outputs lines of magnetic force in an alternating fashion over the cylinder axis direction of the raceway member 16 and an optical, magnetic or other type of scale 20 for use in measuring a moving amount of the moving block 340 side.

On the moving block side 340, there are provided armatures 346 (one mode of the second magnet) which make use of a magnetic force outputted by the magnets 318 which are provided on the raceway member 16 side to generate a magnetic force for generating a thrust in the cylinder axis direction of the raceway member 16, an encoder head 48 which is a reading device of optical, magnetic or other type for use in measuring a moving amount of the moving block 340 side, a slider 50 for transmitting a displacement of the moving block 340 from the opening 15 in the raceway member 16 to a target object to be driven and a coupling member 352 which couples the moving block 340 and the slider 50 together.

In the example shown in FIG. 13, the first magnet and the second magnet are magnets which can control thrust for moving the moving block 340. A permanent magnet may be used for either of the magnets.

In the endless recirculation path 44 in the moving block 40, there are disposed the rolling elements 12 and a retainer 54 which has a shape which matches outer circumferential surfaces of the rolling elements 12 such as bearing balls or bearing rollers so as to hold the rolling elements 12 and serves to reduce resistance and wear which are generated due to contact of the adjacent rolling elements 12 with each other. Note that the retainer 54 may be omitted depending upon applications.

End plates 60, 62, which hold the endless recirculation paths 44 and the like, are provided at both ends of the moving block 340. A cable damper 66 (refer to FIG. 3) for fixing cables 364 may be provided in this end plate 60. The cables 364 are such as to transmit electric power that is to be supplied to the encoder head 48 and a magnetic pole sensor 72 and output signals outputted therefrom, as well as electric power that is to be supplied to the armatures 346. The other ends of the cables 364 which are fixed to the moving block 340 side by the cable damper 66 are connected to a connector provided in the housing 30.

In the example shown in FIG. 13, the slider 50, which constitutes an output shaft of the linear motor actuator 310, is supported in such a manner as to freely move relative to the cylinder axis direction of the raceway member 16 by the rolling elements 12 such as bearing balls or bearing rollers. Consequently, a position or speed control can be implemented on a target object to be driven which is connected directly with the slider 50 by the linear motor generating a thrust which is made up of the magnets 318, the armatures 346, the magnetic pole sensor 72, the scale 20, the encoder head 48 and the like.

By mounting the housings 30, 32 of the linear motor actuator 310 shown in the same figure to the rear of a pulling vehicle (a tractor), the linear motor actuator 310 can be used for an application in which a hitch ball (a spherical protruding portion) provided on the slider 50 is made to constitute a fifth axle of sliding type of the pulling vehicle (the tractor).

In the case where the linear motor actuator 310 is used in this application, a coupler of a pulled vehicle (a trailer) is coupled to the hitch ball of the linear motor actuator 310, so as to move the slider 50 to the left or right according to a steered angle of a steering wheel of the pulling vehicle (the tractor) or the like in order to reduce a difference in turning radius of rear inner wheels of the pulled vehicle (the trailer) when turning to the right or left and to increase the turning capability of the pulled vehicle (the trailer) when reversing.

FIG. 14 is a diagram showing a section taken along the line A-A′ of the linear motor actuator 310 according to the fourth embodiment shown in FIG. 13.

The section taken along the line A-A′ in FIG. 14 is a cross section which intersects the cylinder axis of the raceway member 16 at right angles. The embodiment shown in FIG. 14 is an embodiment in which the moving block 340 and the armatures 346 (the second magnet) are disposed within the same section which intersects the cylinder axis of the raceway member at right angles.

As is shown in FIG. 14, the raceway member 16 of the linear motor actuator 310 has the cylindrical shape of the C-shaped cross section having the opening 15 which results from cutting part of a cylindrical shape. The raceway member 16 has in an interior thereof the plurality of rolling grooves 14 in which the large number of rolling elements 12 such as bearing balls or bearing rollers roll in the cylinder axis direction.

In the example shown in the same figure, a two-row Gothic arch contact construction is adopted in which loads in two directions are supported by employing two rows of rolling element recirculation systems in such a way that the rolling elements 12 contact the rolling element grooves 14 of the raceway member 16 in two locations per ball. The invention is not limited to the example in which the two rows of rolling grooves 14 are provided but may be made to adopt a four-row circular contact construction in which four rows of rolling element recirculation systems of which each system supports a force in one direction by virtue of a single row of rolling elements are provided in such a way that support directions thereof are at right angles to each other. In addition, two rows of rolling grooves which are in angular contact with each other may be provided in two locations (in rolling grooves may be provided in four locations) or may be provided in four or more locations.

In addition, a configuration can also be adopted in which the moving block is made to perform a sliding motion relative to the raceway member without interposing any rolling element between the raceway member and the moving block.

As is shown in the same drawing, the moving block 340 has the rolling element guide grooves 42 for guiding the rolling elements 12 and the endless recirculation paths 44 for recirculating the rolling elements 12 in interiors of the endless recirculation paths 44. The plurality of magnets 318 for outputting alternately lines of magnetic force over the cylinder axis direction of the raceway member 16 is provided on the inner surface of the raceway member 16. In addition, the scale 20 for use in measuring the moving amount of the moving block 40 is provide on the inner surface of the raceway member 16.

As is shown in the same figure, the moving block 340 includes the plurality of armatures 346 for generating magnetic force which generates thrust in the cylinder axis of the raceway member 16 by making use of the magnetic force outputted by the magnets 318 provided on the raceway member 16, a yoke 347 which passes therethrough lines of magnetic force generated by the armatures 346 and a heat insulating material 370 which functions to prevent the transmission of heat generated from the armatures 346 to the moving block 340.

In addition, the slider 50 which connects the moving block 340 to equipment lying outside of the linear motor actuator 310 and the coupling member 352 which couples the slider 50 and the moving block 340 together are fixed to the moving block 340.

As is shown in FIG. 14, in the linear motor actuator 310 of the invention, since the raceway member 16 is configured so as to encapsulate the moving block 340, even in the event that the rolling elements 12 are dislocated from the rolling grooves 14 of the raceway member 16, there occurs no case where the moving block 340 is dislocated from the raceway member 16.

FIG. 15 is a diagram showing a cross section taken along the line B-B′ of the linear motor actuator 310 according to the fourth embodiment shown in FIG. 14.

As is shown in the same figure, the plurality of rolling grooves 14 in which the large number of rolling elements 12 such as bearing balls or bearing rollers roll in the cylinder axis direction are provided on the inner surface of the raceway member 16 of the linear motor actuator 310. Consequently, the moving block 40 can move freely and smoothly relative to the cylinder axis direction in the interior of the raceway member 16.

The plurality of magnets 318 for outputting lines of magnetic force in the alternating fashion over the cylinder axis direction of the raceway member 16 and the scale 20 for use in measuring a moving amount of the moving block 340 side are provided in the interior of the raceway member 16.

The moving block 340 includes the plurality of armatures 346 for outputting magnetic force for generating thrust in the cylinder axis direction of the raceway member 16 by making use of the magnetic force outputted by the magnets 318 provided on the raceway member 16, the yoke 347 which passes therethrough the lines of magnetic force generated by the armatures 346 and the heat insulating material 370 which prevents the transmission of heat generated from the armatures 346 to the moving block 340. In addition, the moving block 340 includes the slider 50 which connects the moving block 340 with equipment lying outside of the linear motor actuator 310 and the coupling member 352 which couples together the slider 50 and the moving block 340.

In the moving block 340, there are provided the endless recirculation paths 44 which allow the rolling elements 12 to be recirculated in the interiors thereof and the end plates 60, 62 for holding the endless recirculation paths 44 and the like. In addition, in the example shown in the same figure, the encoder head 48 for measuring a moving amount of the moving block 40 side is mounted on the end plate 62 of the moving block 340.

In addition, the magnetic pole sensor 72 for measuring a magnetic force generated by the magnets 318 is mounted on the end plate 60 of the moving block 340. The mounting position of the magnetic pole sensor 72 is not limited to the position shown in FIG. 15, and hence, any position can be used, provided that it allows the detection of the magnetic poles of the magnets 318. In addition, since the magnetic pole sensor 72 can be omitted when the positions of the magnets 318 and the armatures are established for use by a so-called power-factor detection method or the like, the linear motor actuator 310 can be miniaturized further.

On the moving block 340, there are provided the encoder head 48 and the magnetic pole sensor 72, and the cable damper 366 for fixing the cables 364 to the moving block 340 side.

The various cables 364 which exit from the cable clamper 366 are connected to the connector provided in the housing 30 via a cable bearer of winding type or the like. In addition, although not shown in the same figure, an origin sensor for the encoder and a driving limit switch may be provided within the linear motor actuator 10.

In addition, as is shown in the same figure, the yoke 347 which generates a thrust is mounted on the moving block 340 which moves freely in the cylinder axis direction via the heat insulating material 370. Since the slider 50 is mounted on the moving block 340 via the coupling member 352, the slider 50 is allowed to move in the cylinder axis direction by virtue of the thrust generated in the yoke 347, whereby a position or speed control can be performed on the slider 50.

Note that when performing the position or speed control on the slider 50 shown in the same figure, this is realized by connecting a driver (not shown) for outputting a controlling electric power to servo control, for example, the plurality of armatures 346 to the linear motor actuator 310.

Positional information outputted by the encoder head 48 and positional information of the magnet which is outputted by the magnetic pole sensor 72 are inputted into the driver, and a host computer for outputting a position command and a speed command or a sequencer is connected to the driver.

When information on a position command or information on a speed command is inputted into the driver from the host controller or the like, the driver outputs controlling drive current to the respective armatures 346 based on the positional information outputted by the encoder head 48 or the positional information on the magnet which is outputted by the magnetic pole sensor 72, so as to control the position or speed of the driver 50.

FIG. 16 is a diagram of a cross section of a linear motor actuator according to a fifth embodiment of the invention which intersects a cylinder axis of a raceway member at right angles.

As is shown in FIG. 16, a raceway member 416 of a linear motor actuator 410 has a closed cylindrical cross-sectional shape, and a portion of the raceway member 416 through which magnetic force of a magnet coupling passes (a portion between an external magnet coupling 94 and an internal magnet coupling 96) is made of a non-magnetic material.

The raceway member 416 has in an interior thereof a plurality of rolling grooves 14 (one mode of the guide portion) in which a large number of rolling elements 12 such as bearing balls or bearing rollers roll in a cylinder axis direction. In an example shown in the same figure, although the rolling grooves 14 are provided in two locations, two rows of rolling grooves may be provided in two locations (the rolling grooves are provided in four locations in total) or may be provided in four or more locations.

A moving block 340 shown in FIG. 16 has a similar configuration to that of the moving block shown in FIG. 13, 14 or 15. In addition, similarly, a plurality of magnets 318 for outputting lines of magnetic force in an alternating fashion over the cylinder axis direction of the raceway member 416 is provided on an inner surface of the raceway member 416. In addition, a scale 20 for use in measuring a moving amount of the moving block 340 side is provided on the inner surface of the raceway member 416.

The internal magnet coupling 96 is provided on an upper portion of the moving block 340 shown in FIG. 16 for transmitting a displacement of the moving block 340 or the like to the outside in order to transmit a drive force of the linear motor actuator 410 to the outside thereof in a non-contact fashion. The internal magnet coupling 96 radiates lines of magnetic force towards the outside of the raceway member 416.

The external magnet coupling 94 is provided outside of the raceway member 416 for driving a slider 98 provided outside of the linear motor actuator 110 by absorbing the magnetic force radiated by the internal magnet coupling 96. In addition, the slider 98 is such as to be used also in vacuo or a clean room and to be guided along guide shafts 99 or the like.

FIG. 17 is view of a cross section taken along the line B1-B′1 of the linear motor actuator 410 shown in FIG. 16.

As is shown in FIG. 17, the plurality of rolling grooves 14 (the mode of the guide portion) in which the number of rolling elements 12 such as bearing balls or bearing rollers roll in the cylinder axis direction. In addition, the plurality of magnets 318 for outputting lines of magnetic force in the alternating fashion over the cylinder axis direction of the raceway member 116 and the scale 20 for use in measuring a moving amount of the moving block 340 side are provided in the interior of the raceway member 416.

The moving block 340 includes a plurality of armatures 346 for outputting magnetic force for generating thrust in the cylinder axis direction of the raceway member 416 by making use of the magnetic force outputted by the magnets 318 provided on the raceway member 416, a yoke 347 which passes therethrough lines of magnetic force generated by the armatures 346 and a heat insulating material 370 which prevents the transmission of heat generated from the armatures 346 to the moving block 340.

The external magnet coupling 94 is provided outside of the raceway member 416 for absorbing the magnetic force radiated by the internal magnet coupling 96 to thereby drive the slider 98 provided outside of the linear motor actuator 410.

As is shown in FIG. 17, by forming the cross-sectional shape of the raceway member 416 of the linear motor actuator 410 into the closed cylindrical shape, the interior of the raceway member 416 and the exterior of the raceway member 416 can be cut off. Consequently, the linear motor actuator 410 can be applied to a field in which an effect of evaporated lubricant of the rolling elements 12 is wanted to be avoided as used, for example, in a vacuum atmosphere, to a field in which there is much dust as in a case where grinding liquid or cuttings fall thereon, to a food-processing field in which mixing of foreign matters is wanted to be avoided, and to various industrial fields which employ clean rooms.

FIG. 18 is a perspective view of a linear motor actuator according to a sixth embodiment of the invention.

As is shown in the same figure, a linear motor actuator 510 includes a cylindrical raceway member 16 which has a cylindrical shape of a C-shaped cross section which has an opening 15 which is narrower than a width of a moving block 540 or the like in part of the cylindrical shape and a guide portion (a rolling groove 14 or the like) for guiding the moving block 540 or the like in a cylinder axis direction, housings 30, 32 which fix the raceway member 16 from both ends thereof and the moving block 540 and the like which are free to move relative to the cylinder axis direction of the raceway member 16 by including a guided portion (a rolling element guide groove 42 or the like) which can be fitted in the guide portion.

A sliding bearing in which the guide portion and the guided portion are fitted together may be used or a rolling element bearing may be used in the guide portion. In an example shown in the same figure, as the guide portion, a plurality of rolling grooves 14 are used in which a large number of rolling elements such as bearing balls, bearing rollers and the like roll in the cylinder axis direction.

The moving block 540 or a moving block 541 has rolling element guide grooves 42 (one mode of the guided portion) which hold to guide the rolling elements 12 from opposite sides of the rolling grooves 14 and endless recirculation paths 44 which allow the rolling elements 12 to be recirculated in interiors thereof to thereby be configured to freely move relative to the cylinder axis direction of the raceway member 16. In addition, the moving block 540 and the moving block 541 are coupled together by a coupling member 552 via a heat insulating material 570.

There are provided in an interior of the raceway member 16 a plurality of magnets 318 (one mode of the first magnet) for outputting lines of magnetic force in an alternating fashion over the cylinder axis direction of the raceway member 16 and a scale 20 for use in measuring a moving amount of the moving block 540 and moving block 541 side.

Armatures 546 (one mode of the second magnet) for generating a thrust in the cylinder axis direction of the raceway member 16 by making use of magnetic force outputted by the magnets 318 provided on the raceway member 16 and a yoke 547 which passes therethrough lines of magnetic force generated by the armatures 546 are provided intermediately between the moving block 540 and the moving block 541. These armatures 546 and the yoke 547 are mounted on the coupling member 552.

In the example shown in FIG. 18, the first magnet and the second magnet are magnets which can control thrust for moving the moving block 540 and the like. A permanent magnet may be used for either of the magnets.

As is shown in FIG. 18, in the sixth embodiment of the invention, the guided portions such as the rolling element guide grooves 42 are disposed within a first cross section of a plurality of cross sections which intersect the cylinder axis of the raceway member 16 at right angles, and the second magnet is disposed within a second cross section which differs from the first cross section having the guided portions in inner configuration.

In addition, in the example shown in the same figure, while the second magnet is described as being disposed between the rolling element guide groove 42 (the guided portion) of the moving block 540 and the rolling element guide groove 42 (the guided portion) of the moving block 541, the invention is not limited to this embodiment and hence, the second magnet may be provided on both sides of the moving block 540 and the moving block 541.

In addition, the two moving blocks, the moving block 540 and the moving block 541, are not always necessary, and either one of the moving block 540 and the moving block 541 may be used and the second magnet may be disposed on one side or both sides of either of the moving blocks.

There are provided on the moving block 540 and moving block 541 side an encoder head 48 which is a reading device of optical, magnetic or other type for use in measuring a moving amount thereof, a slider 50 which is connected to equipment lying outside of the linear motor actuator 510 for transmitting a displacement of the moving block 540 from the opening 15 in the raceway member 16 and the coupling member 552 which couples the moving block 540, the moving block 541 and the yoke 547 and the like to the slider 50.

In the endless recirculation paths 44 in the moving block 540 and the moving block 541, there are disposed the rolling elements 12 and a retainer 54 which has a shape which matches outer circumferential surfaces of the rolling elements 12 such as bearing balls or bearing rollers so as to hold the rolling elements 12 and serves to reduce resistance and wear which are generated due to contact of the adjacent rolling elements 12 with each other.

End plates 560, 561 for holding the endless recirculation path 44 and the like are provided at both ends of the moving block 540. In the example shown in the same figure, a cable damper 366 is provided on the end plate 560 for fixing cables 364 which connect to a magnetic pole sensor 72 and the armatures 546 to the moving block 540 side. The various cables 64 which exit from the cable damper 366 are connected to a connector provided in the housing 30 via a cable bearer 368 of winding type or the like.

End plates 562, 563 are also provided at both ends of the moving block 541. In the example shown in FIG. 18, the encoder head 48 is mounted on the end plate 563.

As is shown in FIG. 18, since the slider 50, which constitutes an output shaft of the linear motor actuator 510, is supported in such a way as to freely slide relative to the cylinder axis direction of the raceway member 16 by the rolling elements 12 such as bearing balls or bearing rollers, a positional or speed control can be performed on a target object to be driven which is connected directly with the slider 50 by the linear motor generating the thrust which is made up of the magnets 318, the armatures 546, the magnetic pole sensor 72, the scale 20, the encoder head 48 and the like.

FIG. 19 is a diagram showing a cross section taken along the line C-C′ of the linear motor actuator 510 according to the sixth embodiment of the invention shown in FIG. 18.

The cross section taken along the line C-C′ in FIG. 18 is defined as a second cross section which intersects the cylinder axis of the raceway member 16 at right angles. The embodiment shown in FIG. 19 is an embodiment in which the armatures 546 (the second magnet) are disposed within the second cross section which dose not have the guided portion (for example, the rolling element guide grooves 42 or the like) of a plurality of different cross sections which intersect the cylinder axis of the raceway member 16 at right angles.

Although the raceway member 16 of the linear motor actuator 510 shown in FIG. 19 has the cylindrical shape of the C-shaped cross section which has the opening 15 provided by cutting part of the cylindrical shape, a closed cylindrical cross-sectional shape such as shown in FIG. 16 may be adopted.

As is shown in FIG. 19, the raceway member 16 has in the interior thereof the plurality of rolling grooves 14 (the mode of the guide portion) in which the large number of rolling elements 12 such as bearing balls or bearing rollers roll in the cylinder axis direction. In the example shown in the same figure, although the rolling grooves 14 are provided in two locations, two rows of rolling grooves may be provided in two locations (the rolling grooves may be provided in four locations in total) or may be provided in four or more locations.

The yoke 547, which passes therethrough lines of magnetic force generated the armatures 246 and transmits heat generated by the armatures 246, is mounted on the coupling member 252. The armatures 546 can generate a thrust in the cylinder axis direction of the raceway member 16 by making use of the magnetic force outputted by the magnets 318 provided on the raceway member 16. In addition, heat generated from the armatures 546 is transmitted to the slider 50 via the yoke 547 and the coupling member 552 and is then radiated to the outside of the linear motor actuator 510.

FIG. 201 is a diagram showing a cross section taken along the line D-D′ of the linear motor actuator 510 according to the sixth embodiment of the invention shown in FIG. 18.

The cross section taken along the line D-D′ in FIG. 18 is defined as a first cross section which intersects the cylinder axis of the raceway member 16 at right angles. The embodiment shown in FIG. 20 is the embodiment in which the rolling element guide groove 42 (the one mode of the guided portion) is disposed within the first cross section which does not have the second magnet (for example, the armatures 546 or the like) in the different cross sections which intersect the cylinder axis of the raceway member 16.

The moving block 241 has, as is shown in FIG. 20, the rolling element guide grooves 42 (the one mode of the guided portion) for guiding the rolling elements 12 and the endless recirculation paths 44 which allow the rolling elements 12 to be recirculated in the interiors thereof.

The plurality of magnets 318 (the one mode of the first magnet) for outputting the lines of magnetic force in the alternating fashion over the cylinder axis direction of the raceway member 16 are provided on the inner surface of the raceway member 16. In addition, the scale 20 for use in measuring a moving amount of the moving block 540 is provided on the inner surface of the raceway member 16.

FIG. 21 is a diagram showing a cross section taken along the line E-E′ of the linear motor actuator 510 according to the sixth embodiment of the invention shown in FIG. 19.

As is shown in the same figure, since the plurality of rolling grooves 14 (the one mode of the guide portion) in which the large number of rolling elements 12 such as bearing balls or bearing rollers roll in the cylinder axis direction are provided on the inner surface of the raceway member 16 of the linear motor actuator 510, the moving block 540 and the moving block 541 can move smoothly and freely in the cylinder axis direction in the interior of the raceway member 16.

The raceway member 16 includes in the interior thereof the magnets 318 (the one mode of the first magnet) and the scale 20 for use in measuring a moving amount of the moving block 540 and moving block 541 side.

There are provided on the coupling member 552 side the plurality of armatures 546 for generating magnetic force for generating thrust in the cylinder axis direction of the raceway member 16 by making use of the magnetic force outputted the magnets 318 provided on the raceway member 16, the yoke 547 which passes therethrough the lines of magnetic force generated by the armatures 546 and the heat insulating material 570 which prevents the transmission of heat generated from the armatures 546 to the moving block 540 and the moving block 541.

Heat generated from the armatures 546 is radiated to the outside of the linear motor actuator 510 via the yoke 547, the coupling member 552 and the slider 50. Consequently, since the rise in temperature of the armatures 546 can be suppressed to some extent, more current can be made to flow to the armatures 546, thereby making it possible to allow the linear motor actuator to produce a large thrust.

The endless recirculation paths 44 which allow the rolling elements 12 to be recirculated in the interiors thereof and the end plates 560, 561, 562, 563 for holding the endless recirculation paths 44 and the like are provided on the moving block 540 and the moving block 541. In addition, in the example shown in the same figure, the encoder head 48 for measuring a moving amount of the moving block 541 side is mounted on the end plate 563 or the like on the moving block 541 side. The encoder head 48 may be mounted on a lower side of the moving block 541 (refer to an encoder head 48′ in FIG. 21).

In addition, a magnetic pole sensor 72 for measuring a magnetic force generated by the magnets 318 is mounted on the end plate 560 on the moving block 540 side. The mounting position of the magnetic pole sensor 72 is not limited to the position shown in FIG. 21, and hence, any position can be used, provided that it allows the detection of the magnetic poles of the magnets 318. The magnetic pole sensor 72 can be omitted when the linear motor actuator 510 is used in an open loop with respect to the magnetic poles of the magnets 318. In addition, the magnetic pole sensor 72 may be mounted on a lower side of the moving block 540 (refer to a magnetic pole sensor 72′ in FIG. 21).

In addition, as is shown in the same figure, the yoke 547, which generates thrust, is mounted on the coupling member 552, and the moving block 540 and the moving block 541, which move freely in the cylinder axis direction, are mounted on this coupling member 552 via the heat insulating material 570. Consequently, the slider 50 mounted on the coupling member 552 moves in the cylinder axis direction by virtue of the thrust generated in the yoke 547, whereby a position or speed control can be implemented thereon.

As is shown in FIGS. 19 and 20, also in the linear motor actuator according to the sixth embodiment of the invention, since the raceway member 16 is configured to encapsulate the moving block 540 and the moving block 541, even in the event that the rolling elements 12 are dislocated from the rolling grooves 14 of the raceway member 16, there occurs no case where the moving block 540 and the moving block 541 are dislocated from the raceway member 16.

Note that when performing the position or speed control on the slider 50 of the linear motor actuator 510 shown in the same figure, this is realized by connecting a driver (not shown) for outputting a controlling electric power for controlling the plurality of armatures 546 in a micro-step fashion to the linear motor actuator 510.

When information on a position command or information on a speed command is inputted to the driver from a host controller or the like, the driver outputs controlling drive current to the respective armatures 546 based on the position information outputted by the encoder head 48 or the position information of the magnets which is outputted by the magnetic pole sensor 72, so as to control the position or speed of the slider 50 in a minute fashion.

As with the embodiment shown in FIG. 4, the linear motor actuator 510 of the sixth embodiment is also characterized by a configuration in which extending portions 17 of the raceway member 16 project as far as above the moving block 540 or the moving block 541.

By this configuration, the cross-sectional shape of the raceway member 16 becomes close to a closed curve, whereby the geometrical moment of inertia of the raceway member 16 can be made large while it is kept compact in external dimensions. Because of this, the linear motor actuator can be obtained which is high in rigidity such as flexural rigidity, torsional rigidity or the like.

In addition, by forming the cross-section shape of the raceway member 16 substantially into the cylindrical shape, the value of cross sectional area and the mass can be reduced while maintaining the geometrical moment of inertia of the raceway member 16 high. In addition, a uniform flexural rigidity can be obtained even for a load in every direction.

Additionally, a dust protecting cover member similar to that shown in FIG. 6 can also be mounted even on the linear motor actuator 510 of the sixth embodiment.

In addition, the raceway member 16 of the linear motor actuator 510 of the sixth embodiment can be configured into a raceway member having a closed cylindrical cross-sectional shape as is shown in FIGS. 16 and 17 and can be configured so as to control a target object to be driven by employing magnet couplings. In this case, too, since the interior of the raceway member and the exterior of the raceway member can be cut off by forming the raceway member into the closed cylindrical shape in cross section, the linear motor actuator 510 can be applied to an application in which it is used in a vacuum atmosphere, to an application in which there is much dust, to a food-processing field, and to an application in which it is used in a clean room.

### INDUSTRIAL APPLICABILITY

According to the invention, the linear motor actuator can be provided which is high in torsional rigidity or flexural rigidity while having the small cross-sectional area and which is lighter in weight and more compact in size. Consequently, the linear motor actuator can preferably be applied to a position where the linear motor actuator itself is rotationally swung as of a distal end shaft of an articulated robot, for example.

In addition, according to the invention, the linear motor actuator can be used even under the environment where there is much dust, the environment where grinding liquid falls, and the clean environment such as a clean room.

### BRIEF DESCRIPTION OF THE DRAWINGS

FIG. 1 A perspective view of a linear motor actuator according to a first embodiment of the invention.

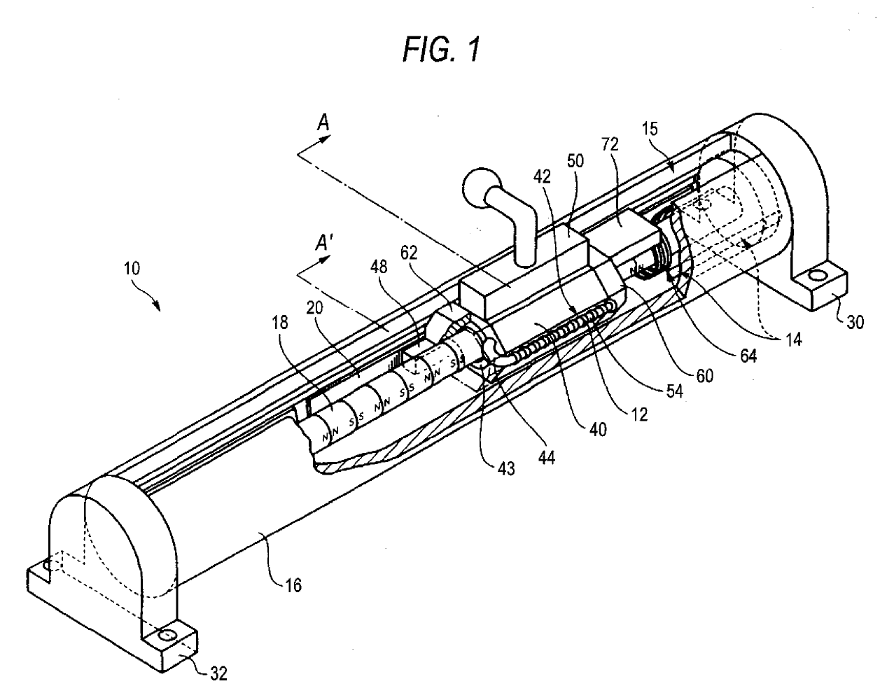

FIG. 2 A drawing showing a cross section taken along the line A-A′ of the linear motor actuator according to the first embodiment shown in FIG. 1.

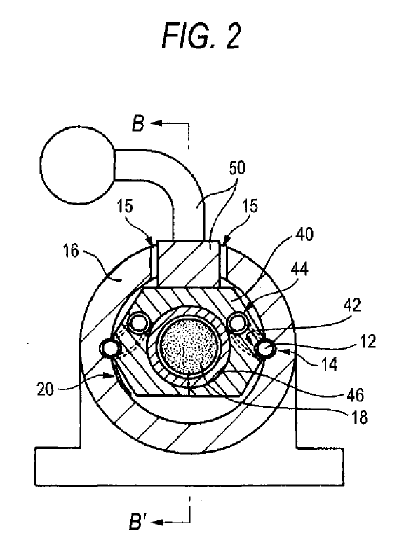

FIG. 3 A drawing showing a cross section taken along the line B-B′ of the linear motor actuator according to the first embodiment shown in FIG. 2.

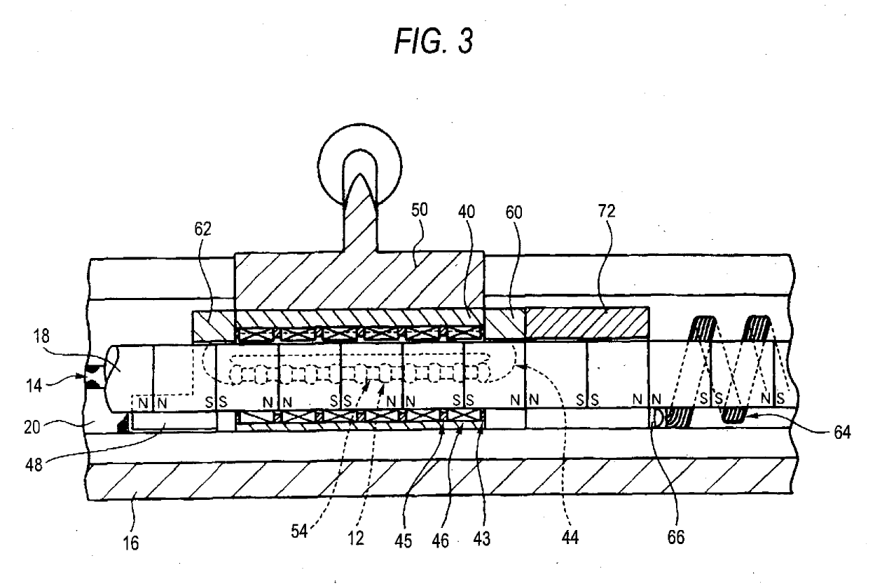

FIG. 4 A drawing which compares a raceway member having a cylindrical cross-sectional shape of the first embodiment of the invention with a conventional raceway member having a U-shaped cross-sectional shape.

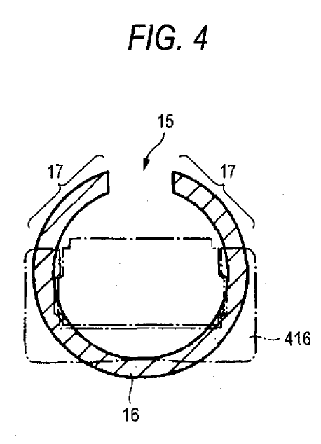

FIG. 5 A drawing which compares configurations of the raceway member of the first embodiment of the invention and the conventional raceway member having the U-shaped cross-sectional shape when their geometrical moments of inertia “IX-X” about an xx axis are made substantially to match.

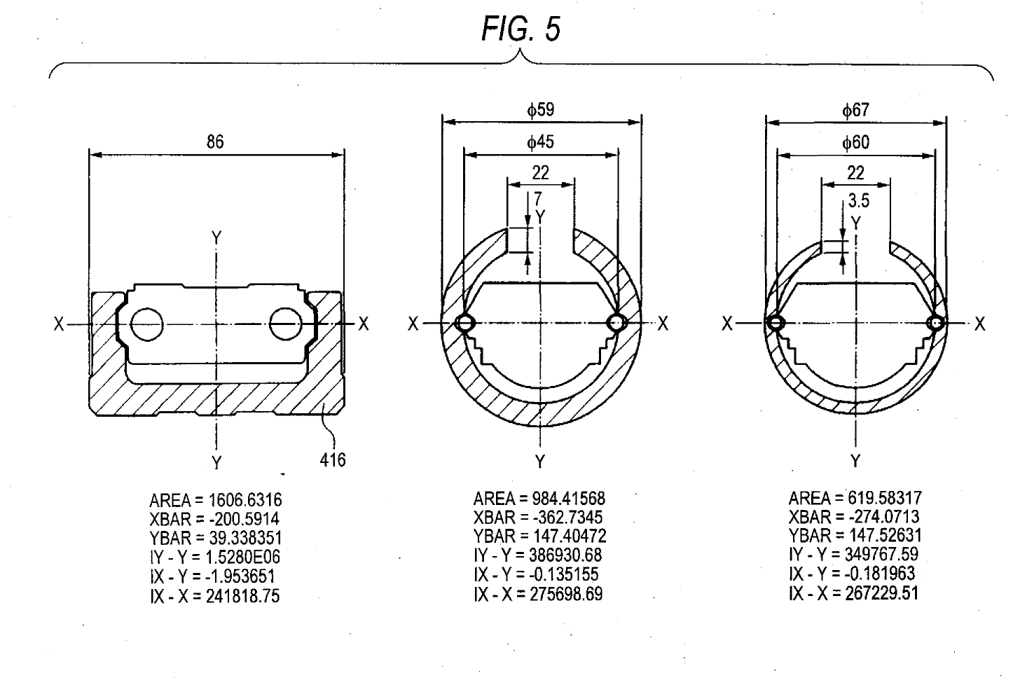

FIG. 6 A perspective view showing a state in which a dust protecting cover member is mounted on the linear motor actuator of the invention.

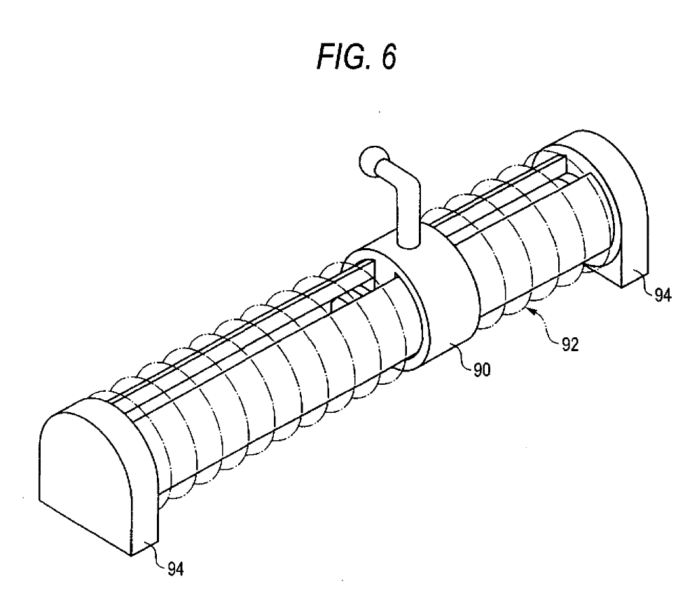

FIG. 7 A drawing showing a cross section of a linear motor actuator according to a second embodiment of the invention which intersects a cylinder axis of a raceway member at right angles.

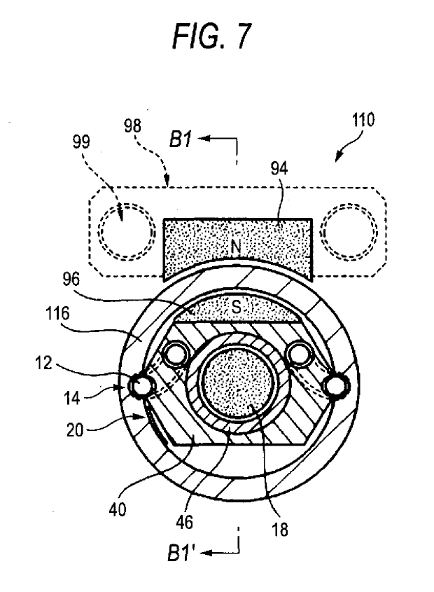

FIG. 8 A cross-sectional view taken along the line B-B′ of the linear motor actuator according to the second embodiment of the invention.

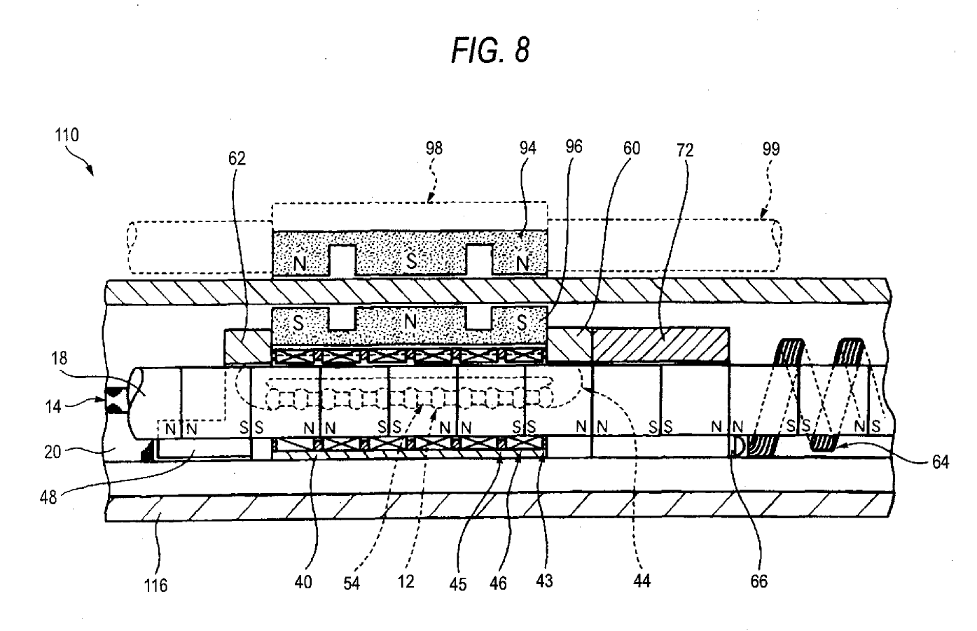

FIG. 9 A perspective view of a linear motor actuator according to a third embodiment of the invention.

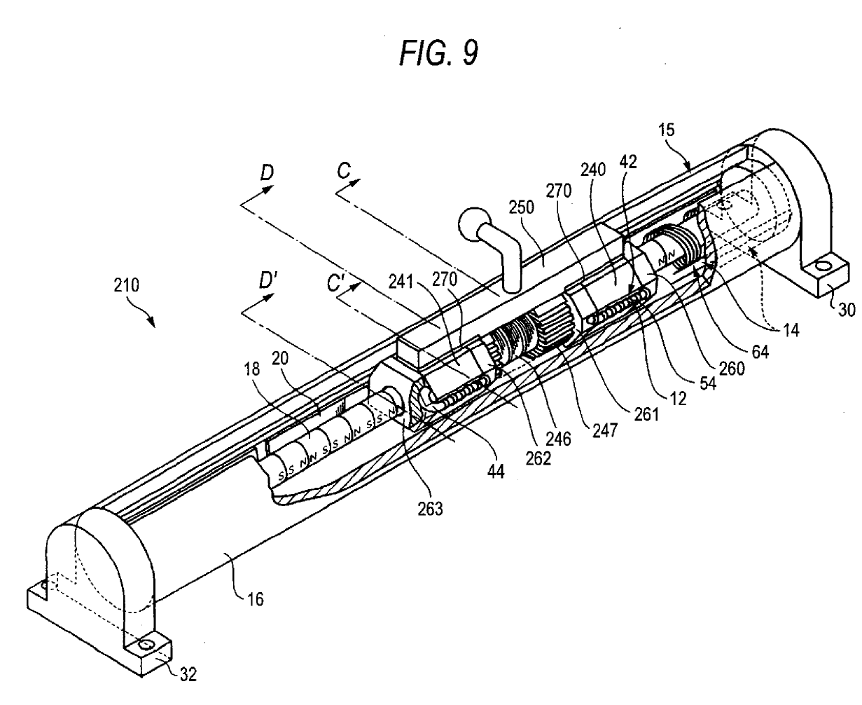

FIG. 10 A drawing showing a cross section taken along the line C-C′ of the linear motor actuator according to the third embodiment of the invention shown in FIG. 9.

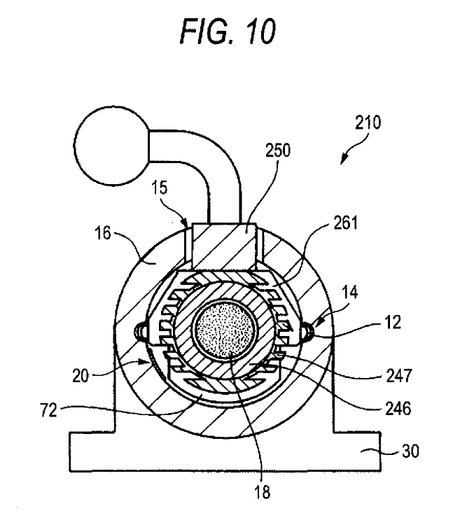

FIG. 11 A drawing showing a cross section taken along the line D-D′ of the linear motor actuator according to the third embodiment of the invention shown in FIG. 9.

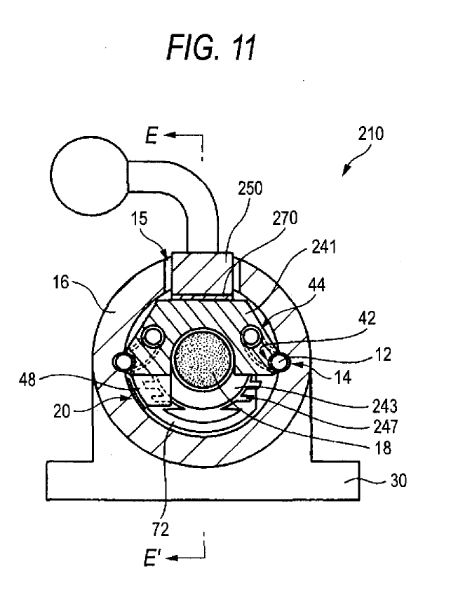

FIG. 12 A drawing showing a cross section taken along the line E-E′ of the linear motor actuator according to the third embodiment of the invention shown in FIG. 10.

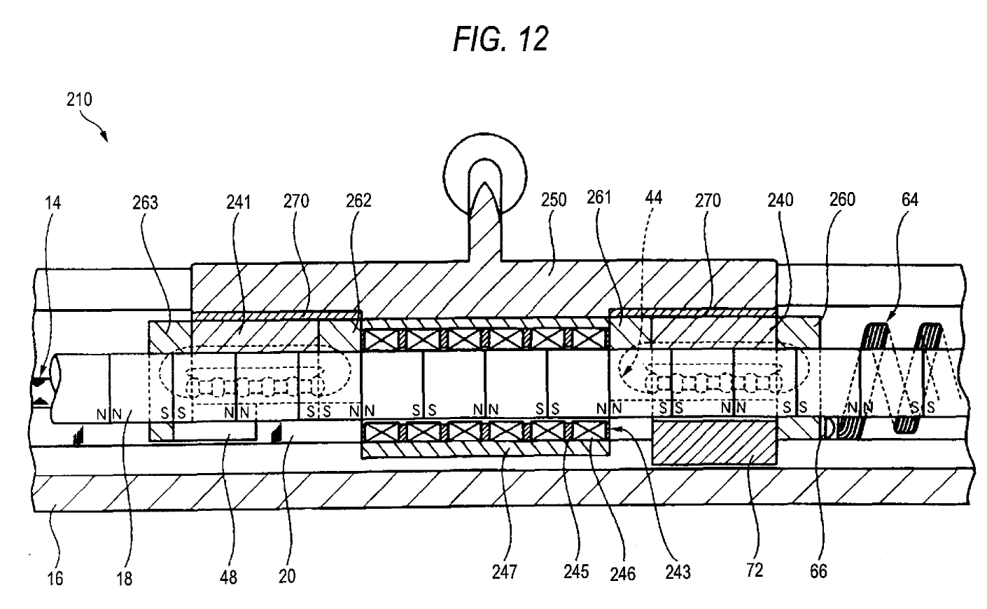

FIG. 13 A perspective view of a linear motor actuator according to a fourth embodiment of the invention.

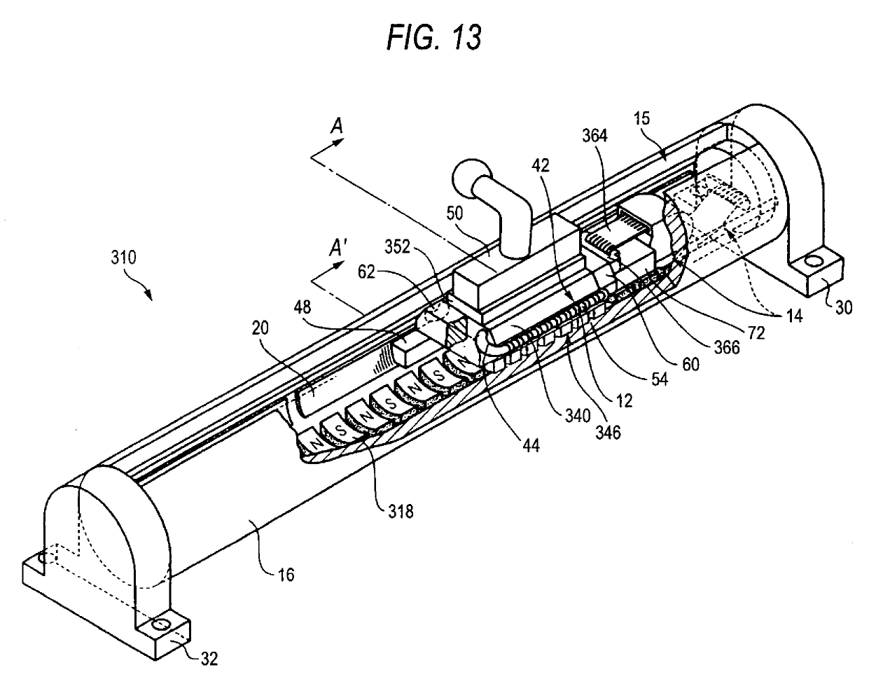

FIG. 14 A drawing showing a cross section taken along the line A-A′ of the linear motor actuator according to the fourth embodiment of the invention shown in FIG. 13.

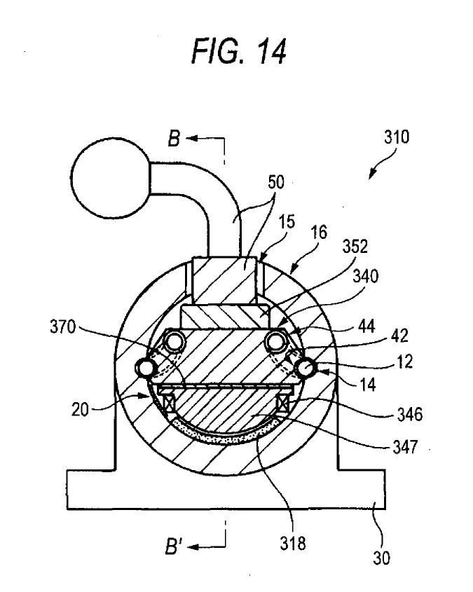

FIG. 15 A drawing showing a cross section taken along the line B-B′ of the linear motor actuator according to the fourth embodiment of the invention shown in FIG. 14.

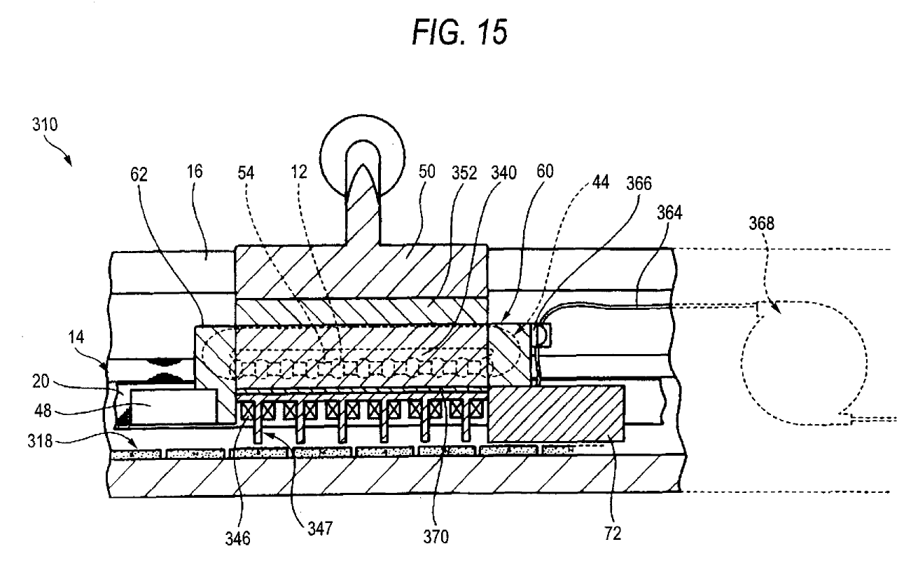

FIG. 16 A drawing showing a cross section of a linear motor actuator according to a fifth embodiment of the invention which intersects a cylinder axis of a raceway member at right angles.

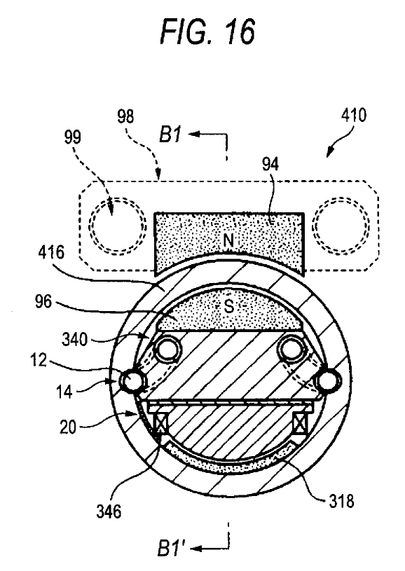

FIG. 17 A cross-sectional view taken along the line B-B′ of the linear motor actuator according to the fifth embodiment of the invention.

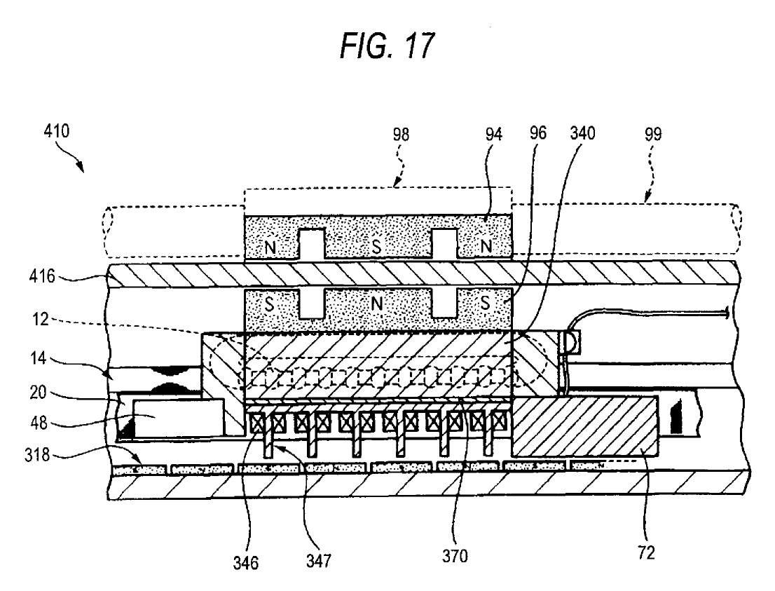

FIG. 18 A perspective view of a linear motor actuator according to a sixth embodiment of the invention.

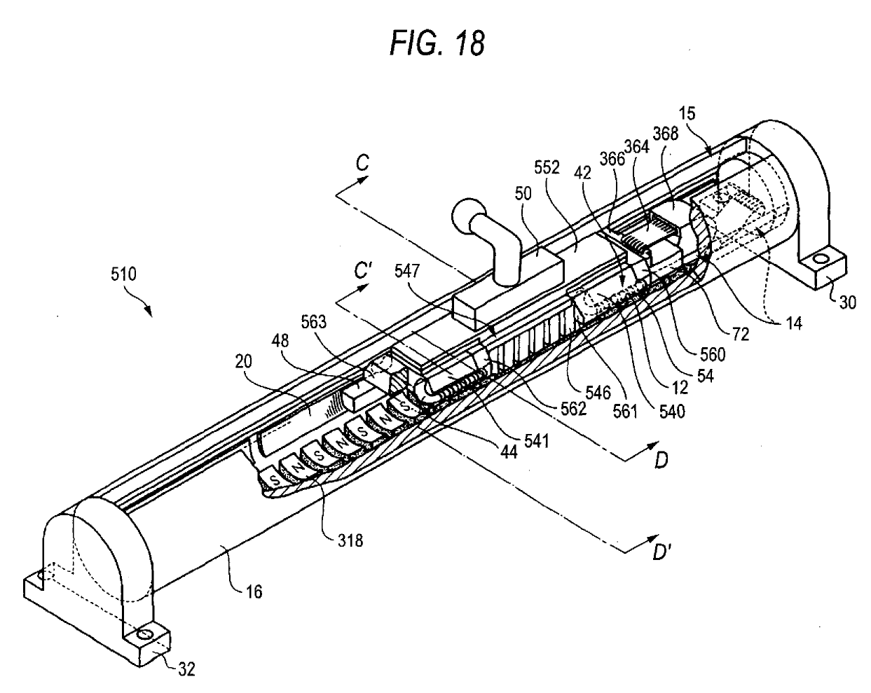

FIG. 19 A drawing showing a cross section taken along the line C-C′ of the linear motor actuator according to the sixth embodiment of the invention shown in FIG. 18.

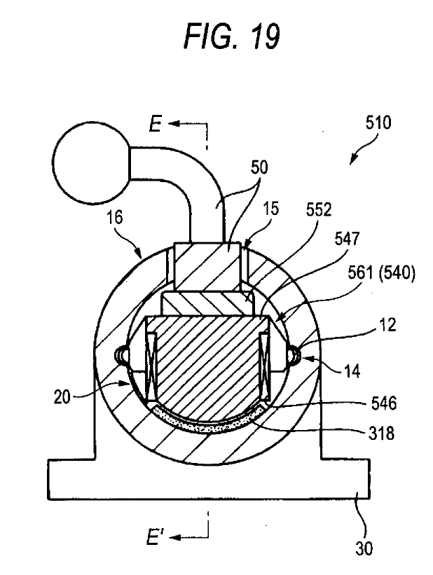

FIG. 20 A drawing showing a cross section taken along the line D-D′ of the linear motor actuator according to the sixth embodiment of the invention shown in FIG. 18.

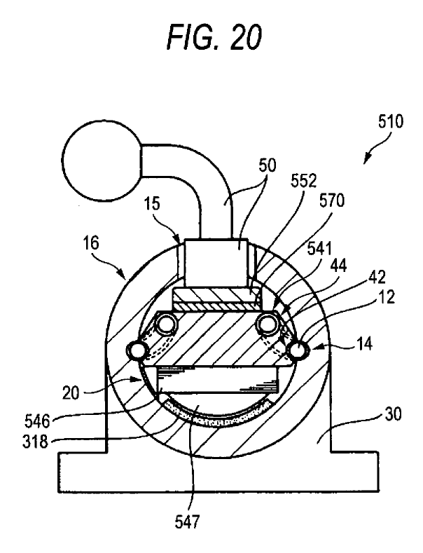

FIG. 21 A drawing showing a cross section taken along the line E-E′ of the linear motor actuator according to the third embodiment of the invention shown in FIG. 18.

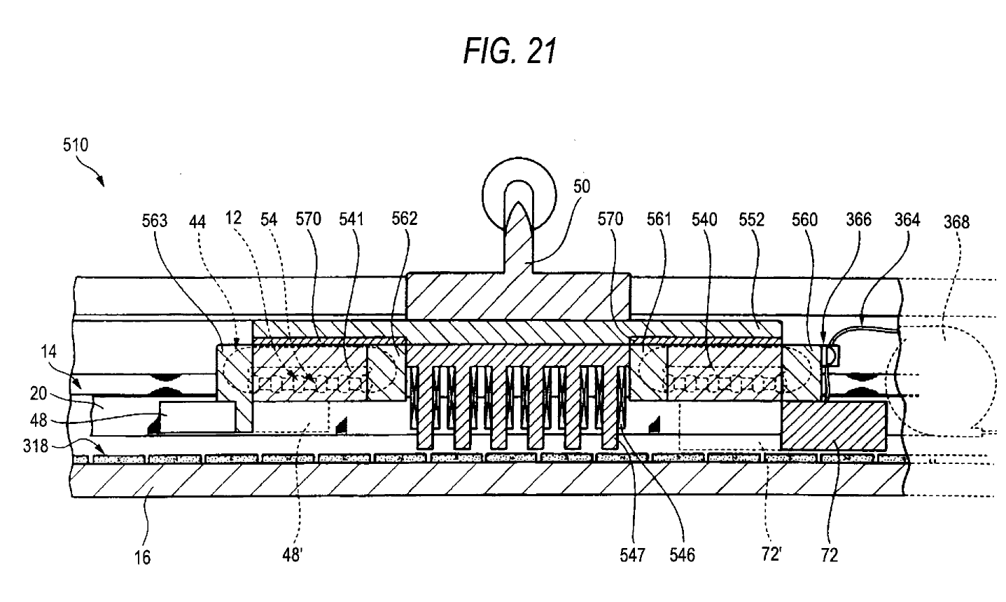

1-10. (canceled)

11. A linear motor actuator comprising:
a moving block;
a raceway member having a cylindrical shape in which the moving block moves in a prismatic or cylindrical hollow portion, the raceway member having a cross-sectional shape which has an opening narrower than a width of the moving block in part of the cylindrical shape and having a guide portion for guiding the moving block in a cylinder axis direction on an inner surface of the cylindrical raceway member;
a first magnet which is formed into a cylindrical or prismatic shape and which resides in an interior of the raceway member to generate a magnetic force; and
a second magnet which is formed into a shape which surrounds the first magnet and which resides on a side of the moving block to generate a magnetic force,
wherein either the first magnet or the second magnet is an electromagnet which can control a thrust for moving the moving block.

12. A linear motor actuator comprising:
a moving block;
a raceway member having a cylindrical shape in which the moving block moves in a prismatic or cylindrical hollow portion, the raceway member having a cross-sectional shape which has an opening narrower than a width of the moving block in part of the cylindrical shape and having a guide portion for guiding the moving block in a cylinder axis direction on an inner surface of the cylindrical raceway member;
a first magnet which resides on an inner surface on the raceway member side to generate a magnetic force; and
a second magnet which resides on the moving block side to generate a magnetic force,
wherein either the first magnet or the second magnet is an electromagnet which can control a thrust for moving the moving block.

13. The linear motor actuator according to claim 11,
wherein the guide portion of the raceway member has a plurality of rolling grooves in which rolling elements such as bearing balls or bearing rollers roll,
wherein the moving block has rolling element guide grooves which hold the rolling elements from opposite sides of the rolling grooves and are supported on the rolling elements so as to move in the cylinder axis direction within the raceway member.

14. The linear motor actuator according to claim 11, wherein the moving block includes a plurality of pieces,
wherein the linear motor actuator further comprises a coupling member that couples each peace of the moving block.

15. The linear motor actuator according to claim 11 further comprising a guided portion which fits in the guide portion within a first cross section of a plurality of cross sections differing from each other which intersect the cylinder axis of the raceway member at right angles,
wherein the second magnet is disposed within a second cross section which differs from the first cross section.

16. The linear motor actuator according to claim 13,
wherein the rolling element guide groove within a first cross section of a plurality of cross sections differing from each other which intersect the cylinder axis of the raceway member at right angles,
wherein the second magnet is disposed within a second cross section which differs from the first cross section.

17. The linear motor actuator according to claim 11, wherein the moving block and the second magnet are disposed within the same cross section which intersects the cylinder axis of the raceway member at right angles.

18. The linear motor actuator according to claim 11 further comprising a covering member which covers the whole of the raceway member and which is free to extend and retract in the cylinder axis direction of the raceway member.

19. A linear motor actuator comprising:
a moving block;
a raceway member having a cylindrical shape in which the moving block moves in a prismatic or cylindrical closed hollow portion, the raceway member having a guide portion for guiding the moving block in a cylinder axis direction on an inner surface of the cylindrical raceway member;
a magnet coupling for transmitting a displacement of the moving block to an outside of the raceway member;
a first magnet which resides on an inner surface on a side of the raceway member to generate a magnetic force; and
a second magnet which resides on a side of the moving block to generate a magnetic force,
wherein either the first magnet or the second magnet is an electromagnet which can control a thrust for moving the moving block.

20. The linear motor actuator according to claim 19, wherein the first magnet is formed into a cylindrical or prismatic shape.

21. The linear motor actuator according to claim 19, wherein the second magnet is formed into a shape which surrounds the first magnet.

22. The linear motor actuator according to claim 12,
wherein the guide portion of the raceway member has a plurality of rolling grooves in which rolling elements such as bearing balls or bearing rollers roll,
wherein the moving block has rolling element guide grooves which hold the rolling elements from opposite sides of the rolling grooves and are supported on the rolling elements so as to move in the cylinder axis direction within the raceway member.

23. The linear motor actuator according to claim 12, wherein the moving block includes a plurality of pieces,
wherein the linear motor actuator further comprises a coupling member that couples each peace of the moving block.

24. The linear motor actuator according to claim 12 further comprising a guided portion which fits in the guide portion within a first cross section of a plurality of cross sections differing from each other which intersect the cylinder axis of the raceway member at right angles,
wherein the second magnet is disposed within a second cross section which differs from the first cross section.

25. The linear motor actuator according to claim 22,
wherein the rolling element guide groove within a first cross section of a plurality of cross sections differing from each other which intersect the cylinder axis of the raceway member at right angles,
wherein the second magnet is disposed within a second cross section which differs from the first cross section.

26. The linear motor actuator according to claim 12, wherein the moving block and the second magnet are disposed within the same cross section which intersects the cylinder axis of the raceway member at right angles.

27. The linear motor actuator according to claim 12 further comprising a covering member which covers the whole of the raceway member and which is free to extend and retract in the cylinder axis direction of the raceway member.
